(19) United States
(12) Patent Application Publication
(10) Pub. No.: US 2012/0200594 A1
(43) Pub. Date: Aug. 9, 2012

(54) DISPLAY CONTROL METHOD, DISPLAY APPARATUS, AND ELECTRONIC APPARATUS

(75) Inventor: Yusuke YAMADA, Matsumoto-shi (JP)

(73) Assignee: SEIKO EPSON CORPORATION, Tokyo (JP)

(21) Appl. No.: 13/368,533

(22) Filed: Feb. 8, 2012

(30) Foreign Application Priority Data
Feb. 9, 2011 (JP) 2011-026368

(51) Int. Cl. G09G 5/00

(52) U.S. Cl. 345/619

(57) ABSTRACT

A display control method includes generating thumbnail images to be displayed on a display unit; displaying the thumbnail images generated in the generating on the display unit; removing a residual image present on the display unit before removing the thumbnail images displayed on the display unit or reducing a display region of the thumbnail images.

### BACKGROUND

1. Technical Field

The present invention relates to a display control method, a display apparatus, and an electronic apparatus.

2. Related Art

As a technique of displaying a document made up of a plurality of pages, a technique disclosed in JP-A-2008-301502 is known, for example. In an image processing apparatus disclosed in JP-A-2008-301502, thumbnail images of pages are displayed on a screen in a matrix form. When it is not possible to display all the pages on the screen, the thumbnail images of the pages which could not be displayed on the screen are displayed by scrolling the screen. When a user designates a page from a list of pages, only the designated page is displayed in an enlarged size.

As a method of changing the displayed image in this way, JP-A-2002-116733 discloses an electrophoretic display apparatus which uses a method of changing the displayed image by applying a voltage corresponding to a difference in gradation before and after change to the pixel electrodes. However, in such a driving method, only pixels of which the gradation is changed are selectively driven. For example, in an electrophoretic display apparatus, when a potential difference is caused to occur between pixel electrodes and a common electrode in order to change the gradation of pixels near a white pixel to black, an electric field extends to a range of adjacent white pixels of which the gradation is not to be changed. As a result, black electrophoretic particles are dispersed up to the region of white pixels of which the gradation is not to be changed. After that, when the pixels changed to black are changed to white again, the black electrophoretic particles dispersed to the region of the white pixels of which the gradation is not changed do not move. As a result, a residual image is formed near the outline of a portion which is displayed in black, and the image being displayed is disturbed. WO2001/091096 discloses a technique of preventing the occurrence of such a residual image. A display apparatus disclosed in WO2001/091096 removes the residual image by refreshing the display when every predetermined period elapses.

According to the invention disclosed in WO2001/091096, the display is refreshed when a predetermined period elapses, whereby the residual image is removed. However, since the residual image is visible until the predetermined period elapses, when removing thumbnail images, for example, the residual image of the thumbnail images may be visible during the period when the display is refreshed.

### SUMMARY

An advantage of some aspects of the invention is to prevent the occurrence of a residual image of thumbnail images even when the display region of the thumbnail images is reduced or removed.

An aspect of the invention is directed to a display control method for displaying an image on a display unit which includes a plurality of scanning lines, a plurality of data lines, and a plurality of pixels formed corresponding to the intersections between the plurality of scanning lines and the plurality of data lines, and which displays an image using a plurality of particles of a first color and a plurality of particles of a second color included in the pixels. The method includes: generating thumbnail images to be displayed on the display unit; displaying the thumbnail images generated in the generating on the display unit; and removing a residual image present on the display unit by moving the particles of the first color and the particles of the second color before removing the thumbnail images displayed on the display unit or reducing a display region of the thumbnail images.

According to the display control method of the above aspect, since particles included in the pixels are moved so that the residual image does not occur before the display region of thumbnail images is reduced or removed, no residual image of the thumbnail image may occur even when the display region of thumbnail images is reduced or removed.

In the display control method of the above aspect of the invention, the residual image may be removed before changing an image outside the display region of the thumbnail images in a state where the thumbnail images are displayed on the display unit.

According to this configuration, since the particles included in the pixels are moved so that the residual image does not occur even when the thumbnail images are being displayed, it is possible to prevent the occurrence of the residual image even when the display region of the thumbnail images is reduced or removed.

In the display control method of the above aspect of the invention, the gradations of the pixels may be changed by a writing operation of applying a voltage to the pixels several times, and the method may further include determining pixels of which the gradation is to be changed among the plurality of pixels by comparing image data representing an image to be newly displayed on the display unit and scheduled image data representing an image scheduled to be displayed on the display unit, and starting the writing operation with respect to the pixels which are determined to be the pixels of which the gradation is to be changed and in which the writing operation is not being performed so that the pixels have a gradation set by the image data, and starting the writing operation with respect to the pixels which are determined to be the pixels of which the gradation is to be changed and in which the writing operation is being performed so that the pixels have a gradation set by the image data after the writing operation being performed is finished.

According to this configuration, since the writing operation is immediately started with respect to the pixels of which the gradation is to be changed and in which the writing operation is not being performed, the user can experience a faster display speed.

Another aspect of the invention is directed to a display apparatus including: a display unit which includes a plurality of scanning lines, a plurality of data lines, and a plurality of pixels formed corresponding to the intersections between the plurality of scanning lines and the plurality of data lines, and which displays an image using a plurality of particles of a first color and a plurality of particles of a second color included in the pixels; a display image generation unit that generates thumbnail images to be displayed on the display unit; a controller that causes the thumbnail images generated by the display image generation unit to be displayed on the display unit; and a residual image removal unit that removes a residual image present on the display unit by moving the particles of the first color and the particles of the second color before removing the thumbnail images displayed on the display unit or reducing a display region of the thumbnail images.

According to the display apparatus of the above aspect, since particles included in the pixels are moved so that the residual image does not occur before the display region of thumbnail images is reduced or removed, no residual image of the thumbnail image may occur even when the display region of thumbnail images is reduced or removed.

The invention is not only a display apparatus but can also be realized as an electronic apparatus having the display apparatus.

### BRIEF DESCRIPTION OF THE DRAWINGS

The invention will be described with reference to the accompanying drawings, wherein like numbers reference like elements.

FIG. 1 is a diagram showing an appearance of an electronic apparatus according to an embodiment of the invention.

FIG. 2 is a block diagram showing a hardware configuration of the electronic apparatus.

FIG. 3 is a cross-sectional view of a display unit.

FIG. 4 is a diagram illustrating a circuit configuration of the display unit.

FIG. 5 is a diagram illustrating the configuration of a pixel driving circuit.

FIG. 6 is a block diagram showing the configuration of functions related to displaying of pages and thumbnail images.

FIG. 7 is a flowchart showing the flow of processes executed by the electronic apparatus.

FIG. 8 is a flowchart showing the flow of processes executed by the electronic apparatus.

FIG. 9 is a flowchart showing the flow of processes executed by the electronic apparatus.

FIG. 10 is a flowchart showing the flow of processes executed by the electronic apparatus.

FIG. 11 is a flowchart showing the flow of processes executed by the electronic apparatus.

FIGS. 12A to 12E are diagrams illustrating a process of modifying thumbnail images.

FIG. 13 is a diagram showing an image displayed on the display unit.

FIG. 14 is a diagram showing an image displayed on the display unit.

FIG. 15 is a diagram showing an image displayed on the display unit.

FIG. 16 is a diagram showing an image displayed on the display unit.

FIG. 17 is a diagram showing an image displayed on the display unit.

FIG. 18 is a diagram showing an image displayed on the display unit.

FIG. 19 is a diagram showing an image displayed on the display unit.

FIG. 20 is a block diagram showing the configuration of functions realized by a controller.

FIG. 21 is a flowchart showing the flow of processes performed by the controller.

FIG. 22 is a diagram illustrating an image rewrite operation.

FIG. 23 is a diagram illustrating an image rewrite operation.

FIG. 24 is a diagram illustrating an image rewrite operation.

FIG. 25 is a diagram illustrating an image rewrite operation.

FIG. 26 is a diagram illustrating an image rewrite operation.

FIG. 27 is a diagram illustrating an image rewrite operation.

FIG. 28 is a diagram illustrating an image rewrite operation.

FIG. 29 is a diagram illustrating an image rewrite operation.

FIG. 30 is a diagram illustrating an image rewrite operation.

FIG. 31 is a diagram illustrating an image rewrite operation.

FIG. 32 is a diagram illustrating an image rewrite operation.

FIG. 33 is a diagram illustrating an image rewrite operation.

FIG. 34 is a diagram illustrating an image rewrite operation.

FIG. 35 is a diagram illustrating an image rewrite operation.

FIG. 36 is a diagram illustrating an image rewrite operation.

FIG. 37 is a diagram illustrating an image rewrite operation.

FIG. 38 is a diagram showing an image displayed on the display unit.

FIG. 39 is a diagram showing thumbnail images displayed on the display unit.

FIG. 40 is a diagram showing an image displayed on the display unit.

FIG. 41 is a diagram showing an image displayed on the display unit.

### DESCRIPTION OF EXEMPLARY EMBODIMENTS

### Embodiment

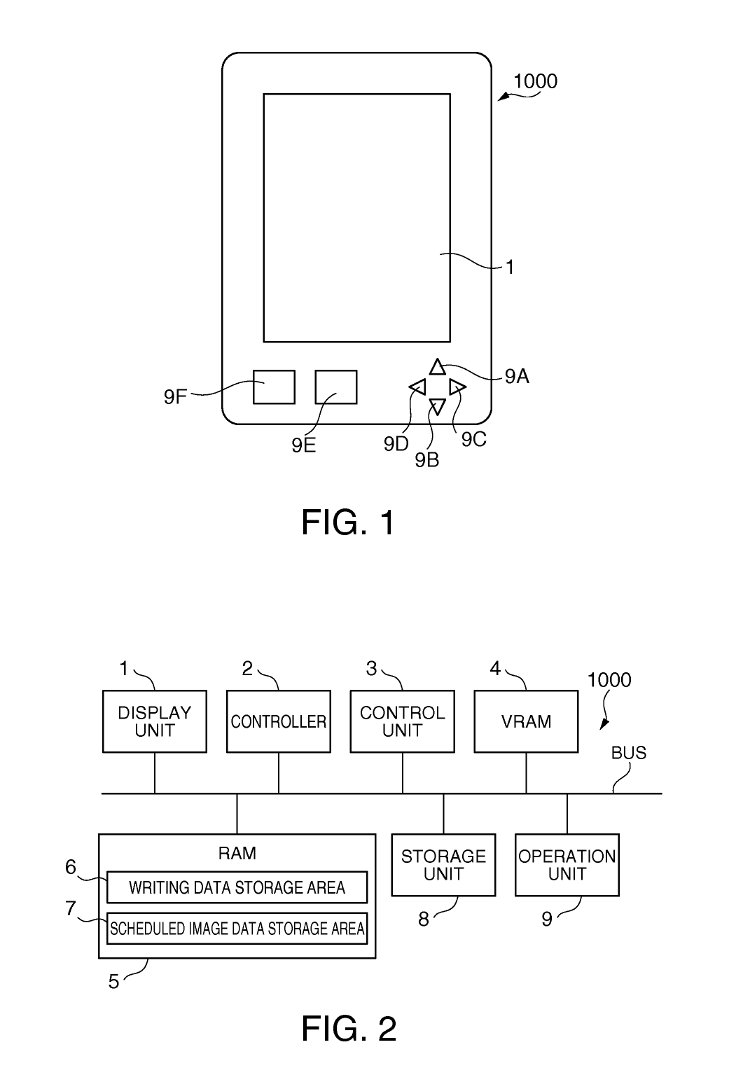

FIG. 1 is a diagram showing an appearance of an electronic apparatus 1000 according to an embodiment of the invention. The electronic apparatus 1000 is an apparatus (commonly called an ebook reader) for browsing an ebook which is an example of a document. The electronic apparatus 1000 displays the pages of an ebook and thumbnails which are reduced images of the respective pages of the ebook. That is, the electronic apparatus 1000 is an example of a display apparatus that displays images. The electronic apparatus 1000 includes a display unit 1 on which images are displayed. Moreover, the electronic apparatus 1000 includes buttons 9A to 9F as operation units operated by a user.

FIG. 2 is a block diagram showing a hardware configuration of the electronic apparatus 1000. As shown in FIG. 2, the respective units of the electronic apparatus 1000 are connected to a bus BUS. The respective units of the electronic apparatus 1000 exchange signals between them through the bus BUS.

The display unit 1 is a display device which includes a display element having a memory effect, and in which a displayed image is maintained even when no voltage is applied to the display element. In the present embodiment, the display unit 1 includes a display element having electrophoretic particles and displays black and white images.

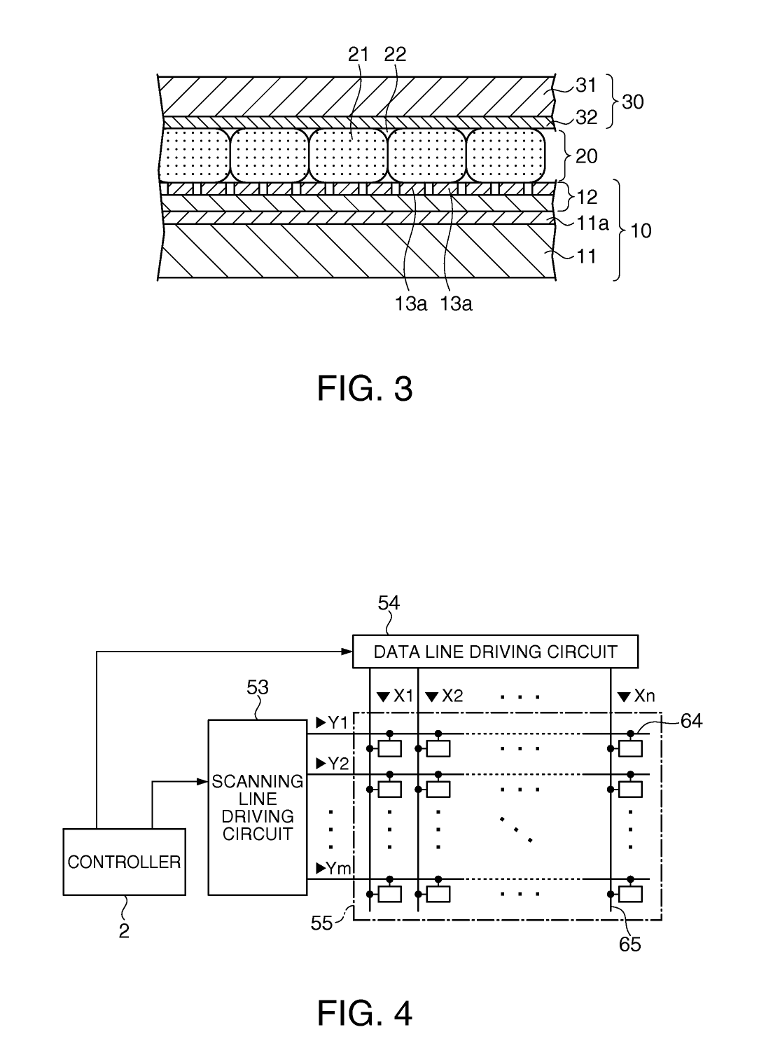

FIG. 3 is a cross-sectional view of the display unit 1. FIG. 4 is a diagram illustrating a circuit configuration of the display unit 1. As shown in FIG. 3, the display unit 1 mainly includes a first substrate 10, an electrophoretic layer 20, and a second substrate 30. The first substrate 10 is a substrate in which a circuit layer is formed on a substrate 11 having insulating and flexible properties. In the present embodiment, the substrate 11 is formed of polycarbonate. The material of the substrate 11 is not limited to polycarbonate, but a resin material which is light, flexible, elastic, and insulative can also be used. Moreover, the substrate 11 may be formed of glass which is not flexible. An adhesive layer 11a is formed on the surface of the substrate 11, and a circuit layer 12 is stacked on the surface of the adhesive layer 11a.

The circuit layer 12 includes a plurality of scanning lines 64 arranged in the horizontal direction and a plurality of data lines 65 arranged in the vertical direction so as to be electrically isolated from the respective scanning lines 64. Moreover, the circuit layer 12 includes a pixel electrode 13a (first electrode) and a pixel driving circuit configured as a TFT (Thin Film Transistor), which are provided corresponding to each intersection between the scanning lines 64 and the data lines 65.

The electrophoretic layer 20 includes a binder 22 and a plurality of microcapsules 21 fixed by the binder 22 and is formed on the pixel electrodes 13a. An adhesive layer formed by an adhesive agent may be formed between the microcapsules 21 and the pixel electrodes 13a.

The material of the binder 22 is not particularly limited as long as it has satisfactory affinity to the microcapsules 21, excellent adhesion to electrodes, and insulating properties. A dispersion medium and the electrophoretic particles are contained in the microcapsule 21. As the material of the microcapsule 21, materials having flexibility such as gelatin-gum arabic compounds or urethane compounds are preferably used.

Examples of the dispersion medium include any one of water, alcohol solvents (methanol, ethanol, isopropanol, butanol, octanol, methyl cellosolve, and the like), esters (ethyl acetate, butyl acetate, and the like), ketones (acetone, methyl ethyl ketone, methyl isobutyl ketone, and the like), aliphatic hydrocarbons (pentane, hexane, octane, and the like), alicyclic hydrocarbons (cyclo-hexane, methyl cyclo-hexane, and the like), aromatic hydrocarbons (benzene, toluene, benzenes having long-chain alkyl groups (xylene, hexyl-benzene, heptyl-benzene, octyl-benzene, nonyl benzene, decyl benzene, undecyl benzene, dodecyl-benzene, tridecyl-benzene, a tetradecyl-benzene, and the like)), halogenated hydrocarbons (methylene chloride, chloroform, carbon tetrachloride, 1,2-dichloroethane, and the like), and carboxylate. Moreover, other oils may be used. These materials may be used alone or as mixtures, and surface active agents may be added thereto as well.

The electrophoretic particles are particles (high polymers or colloids) having a property such that they move within the dispersion medium by the application of an electric field. In the present embodiment, white electrophoretic particles (particles of the first color) and black electrophoretic particles (particles of the second color) are stored in the microcapsules 21. The black electrophoretic particles are particles made of a black pigment such as, for example, aniline black, carbon black, or the like, and in the present embodiment, are positively charged. The white electrophoretic particles are particles made of a white pigment such as, for example, titanium dioxide, aluminum oxide, or the like, and in the present embodiment, are negatively charged.

The second substrate 30 includes a film 31 and a transparent electrode layer 32 (second electrode) formed on the lower surface of the film 31. The film 31 has the role of sealing and protecting the electrophoretic layer 20 and is a polyethylene terephthalate film. The film 31 is transparent and has insulating properties. The transparent electrode layer 32 is formed of a transparent conductive film such as, for example, an indium oxide film (ITO film), or the like.

Next, the circuit included in the display unit 1 will be described. The plurality of data lines 65 arranged in parallel in the vertical direction and the plurality of scanning lines 64 arranged in parallel in the horizontal direction are formed in a display region 55 shown in FIG. 4. Moreover, pixel driving circuits are formed in the display region 55 corresponding to the intersections between the data lines 65 and the scanning lines 64.

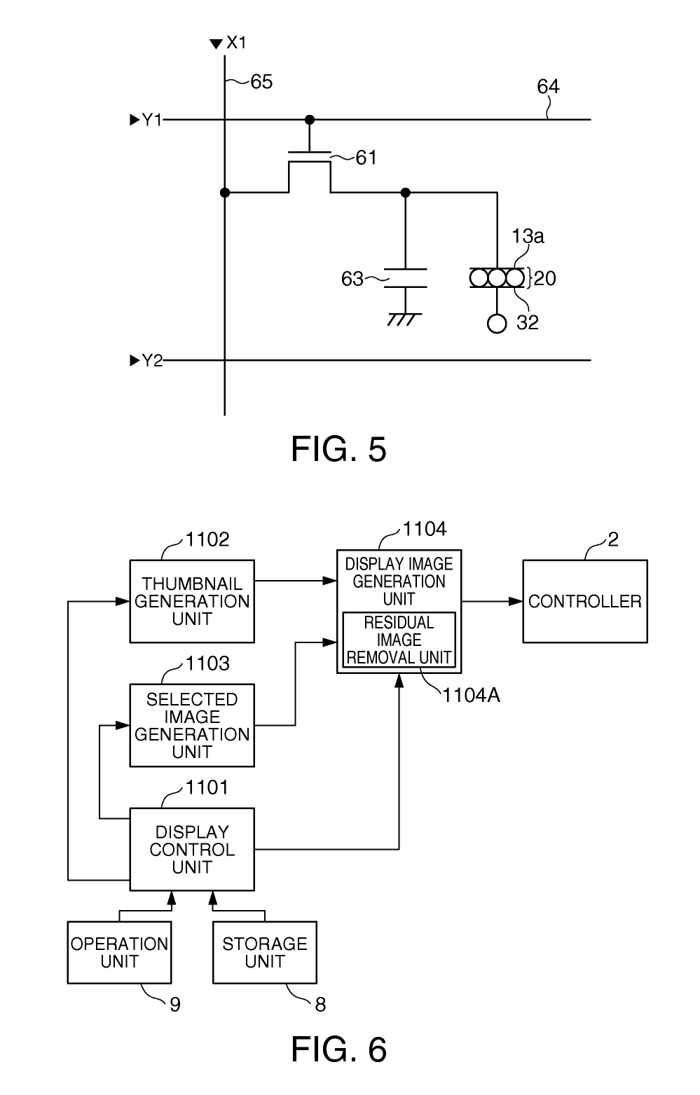

FIG. 5 is a diagram illustrating the configuration of the pixel driving circuit. In the present embodiment, the scanning lines 64 are sometimes referred to as 1st, 2nd, 3rd, (m−1)-th and m-th scanning lines in that order from the top of FIG. 4 in order to distinguish the respective scanning lines 64 from each other. Similarly, the data lines 65 are sometimes referred to as 1st, 2nd, 3rd, (n−1)-th and n-th data lines in that order from the left side of FIG. 4 in order to distinguish the respective data lines 65 from each other.

In FIG. 5, a pixel driving circuit corresponding to the intersection between the first scanning line 64 and the first data line 65 is shown. Although the same pixel driving circuits are formed corresponding to the intersections of the other data lines 65 and the other scanning lines 64, since the respective pixel driving circuits have the same configuration, the pixel driving circuit corresponding to the intersection between the first data line and the first scanning line will be described as representative. Description of the other pixel driving circuits will not be provided.

In the pixel driving circuit, the gate of a transistor 61 is connected to the scanning line 64, and the source of the transistor 61 is connected to the data line 65. Moreover, the drain of the transistor 61 is connected to the pixel electrode 13a. The pixel electrode 13a faces the transparent electrode layer 32, and the electrophoretic layer is disposed between the pixel electrode 13a and the transparent electrode layer 32. One microcapsule 21 between the pixel electrode 13a and the transparent electrode layer 32 serves as one pixel of the display unit 1. In the pixel driving circuit, a storage capacitor 63 is connected in parallel to the electrophoretic layer 20. Moreover, the potential of the transparent electrode layer 32 is at a predetermined potential Vcom.

A scanning line driving circuit 53 is connected to the respective scanning lines 64 of the display region 55 so as to supply scanning signals Y1, Y2, . . . , and Ym to the first, second, . . . , and m-th scanning lines 64. Specifically, the scanning line driving circuit 53 sequentially selects the first, second, . . . , and m-th scanning lines 64, sets the voltage of the scanning signal of the selected scanning line 64 to a selection voltage VH (H level), and sets the voltage of the scanning signal of non-selected scanning lines to a non-selection voltage VL (L level).

A data line driving circuit 54 is connected to the respective data lines of the display region so as to supply data signals X1, X2, . . . , and Xn to the first, second, . . . , n-th data lines 65. Data signals are supplied from the data lines 65 to pixel driving circuits connected to the scanning lines 64 of which the potentials are at the selection voltage VH. Specifically, when the scanning line 64 is at the H level, the transistors 61 of which the gates are connected to the scanning line 64 are turned on, and the pixel electrodes 13a are connected to the data lines 65. Therefore, when data signals are supplied to the data lines 65 when the scanning line 64 is at the H level, the data signals are applied to the pixel electrodes 13a through the transistors 61 in the ON state. When the scanning line 64 is at the L level, although the transistors 61 are turned off, the voltage applied to the pixel electrodes 13a in accordance with the data signal is stored in the storage capacitor 63, and electrophoretic particles move in response to a potential difference (voltage) between the potential of the pixel electrode 13a and the potential of the transparent electrode layer 32.

For example, when the transparent electrode layer 32 is at the potential of Vcom and the pixel electrode 13a is at the potential of +15 V, white electrophoretic particles in the negatively charged state move toward the pixel electrode 13a, and black electrophoretic particles in the positively charged state move toward the transparent electrode layer 32, whereby the pixel appears black. Moreover, when the transparent electrode layer 32 is at the potential of Vcom and the pixel electrode 13a is at the potential of −15 V, black electrophoretic particles in the positively charged state move toward the pixel electrode 13a, and white electrophoretic particles in the negatively charged state move toward the transparent electrode layer 32, whereby the pixel appears white.

In the following description, a period after the scanning line driving circuit 53 selects the first scanning line and before selection of the Y-th scanning line is finished will be referred to as a “frame period” or simply “frame”. Each scanning line 64 is selected every frame, and the data signal is supplied to each pixel driving circuit every frame.

Returning to FIG. 2, a controller 2 outputs signals for displaying images in the display region 55 and various kinds of signals for driving the display unit 1. A control unit 3 is a microcomputer including a CPU (Central Processing Unit), a ROM (Read Only Memory), a RAM (Random Access Memory), and the like, and controls the respective units of the electronic apparatus 1000 in accordance with a program stored in the ROM. Moreover, the control unit 3 accesses a VRAM (Video RAM) 4 to write various kinds of data to the VRAM 4. The VRAM 4 is a memory that stores image data representing images to be displayed on the display unit 1. The RAM 5 stores data used for displaying images on the display unit 1. The data stored in the RAM 5 will be described later. A storage unit 8 is a nonvolatile memory and stores document data representing an ebook. The storage unit 8 can store data of a plurality of different documents. An operation unit 9 includes buttons 9A to 9F shown in FIG. 1. When anyone of the buttons is operated, a signal indicating the operated button is transmitted to the control unit 3. The control unit 3 acquires the signal transmitted from the operation unit 9 and specifies the operated button. The control unit 3 performs various processes in accordance with the specified button, such as, for example, forward and backward scrolling of ebook pages, displaying or undisplaying of thumbnail images, moving of the selected thumbnail images, or removing residual images. The display unit 1, the controller 2, and the control unit 3 may collectively be defined as a display apparatus. Alternatively, the display unit 1, the controller 2, the control unit 3, the VRAM 4, and the RAM 5 may collectively be defined as a display apparatus.

FIG. 6 is a block diagram showing the configuration of functions related to displaying of pages and thumbnail images of an ebook in the electronic apparatus 1000. A thumbnail generation unit 1102 generates thumbnail images of respective pages of a document represented by document data based on data supplied from a display control unit 1101. A selected image generation unit 1103 generates an image (hereinafter referred to as a first selected image) of an open page of an ebook, selected by the user, based on the data supplied from the display control unit 1101. A display image generation unit 1104 acquires the thumbnail images generated by the thumbnail generation unit 1102 and the first selected image generated by the selected image generation unit 1103 and generates an image to be displayed on the display unit 1 using the acquired images. A residual image removal unit 1104A included in the display image generation unit 1104 generates an image such that all pixels of the display region 55 have the same gradation. The display control unit 1101 acquires the signal indicating the operated button of the operation unit 9. Moreover, the display control unit 1101 reads the document data from the storage unit 8 in response to the acquired signal and supplies the data of the respective pages included in the read document data to the thumbnail generation unit 1102. Furthermore, the display control unit 1101 extracts the data of an open page of the ebook, selected by the user from the document data and supplies the extracted data to the selected image generation unit 1103.

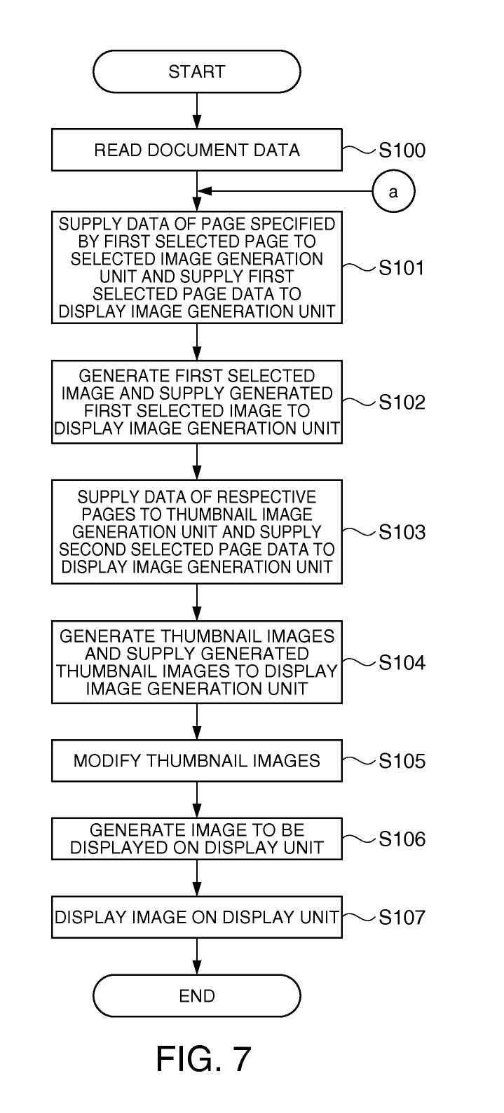

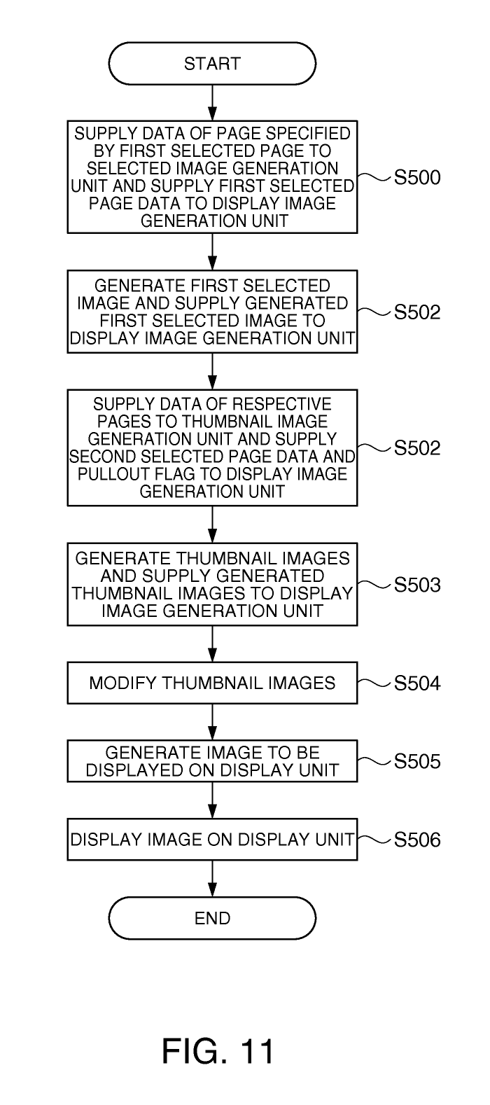

FIGS. 7 to 11 are flowcharts showing the flow of processes executed by the electronic apparatus 1000. Hereinafter, the operation of the electronic apparatus 1000 will be described with reference to FIGS. 7 to 11.

First, when the user operates the operation unit 9 to select one of a plurality of document data stored in the storage unit 8, the display control unit 1101 reads the selected document data from the storage unit 8 (FIG. 7: step S100). The display control unit 1101 includes first selected page data representing the number of an open page (hereinafter referred to as a first selected page) selected by the user. When reading of the document data is finished, the display control unit 1101 extracts the data of a page specified by the first selected page from the document data, supplies the extracted data to the selected image generation unit 1103, and supplies the first selected page data to the display image generation unit 1104 (step S101). For example, when the value of the first selected page data is “16,” the display control unit 1101 extracts the data of page 16 from the document data and supplies the extracted data to the selected image generation unit 1103. The selected image generation unit 1103 generates an image of the page indicated by the supplied data and supplies the generated first selected image to the display image generation unit 1104 (step S102).

Moreover, the display control unit 1101 includes second selected page data representing the number of a page (hereinafter referred to as a second selected page) corresponding to a thumbnail image selected by the user. The display control unit 1101 supplies the data of the respective pages of a document represented by the document data to the thumbnail generation unit 1102 and supplies the second selected page data to the display image generation unit 1104 (step S103). The thumbnail generation unit 1102 generates thumbnail images of the respective pages represented by the supplied data and supplies the generated thumbnail images to the display image generation unit 1104 (step S104).

The display image generation unit 1104 generates an image including the supplied first selected image and thumbnail images as an image to be displayed on the display unit 1. The thumbnail images of the respective pages are modified so that each page is erected vertically on a horizontal plane and rotated about an imaginary rotation axis crossing the upper and lower sides of the page, and the page is viewed in the same way as when it was viewed (viewed overhead) from a viewpoint above the upper side of the page (step S105).

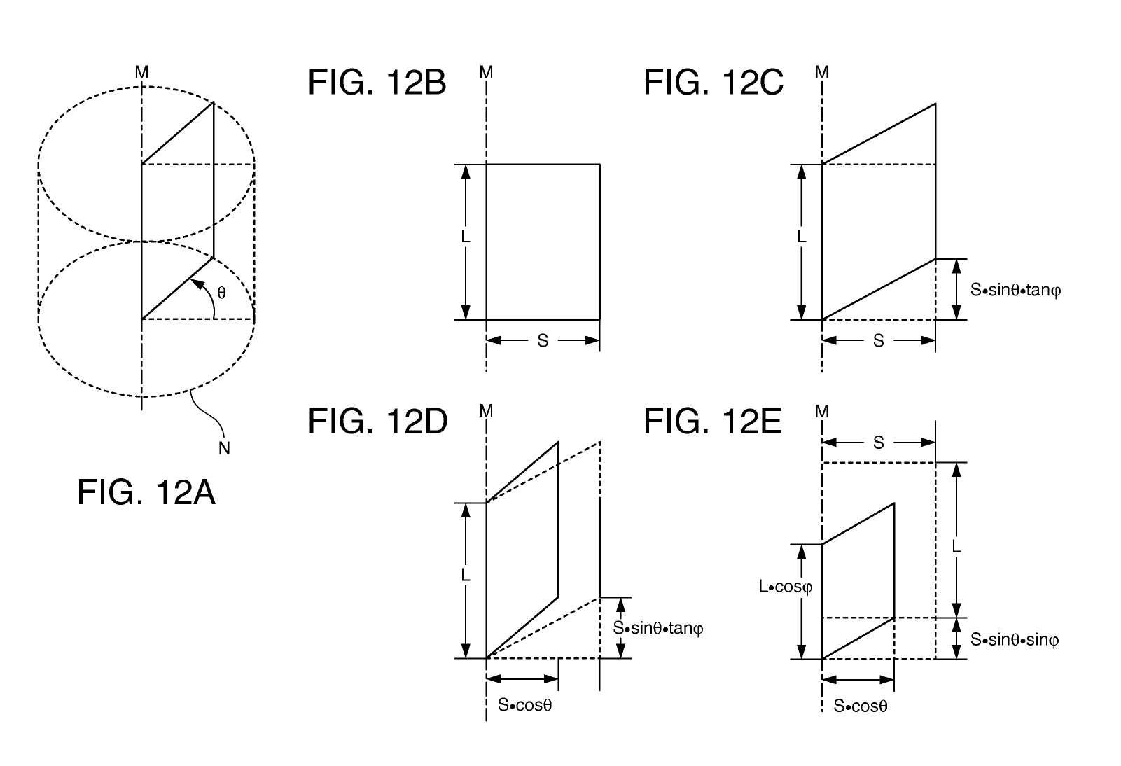

FIGS. 12A to 12E are diagrams illustrating a process of modifying thumbnail images. The respective thumbnail images supplied from the thumbnail generation unit 1102 are plan-view images of pages. As shown in FIG. 12B, each thumbnail image is an image in which the vertical length is L, the horizontal length is S, the vertical sides are parallel to the vertical direction of the display region, and the horizontal sides are parallel to the horizontal direction of the display region. The display image generation unit 1104 modifies the respective thumbnail images representing the pages to thereby generate images so that as shown in FIG. 12A, each page is erected on a horizontal plane N in an imaginary space and rotated about an imaginary rotation axis M crossing the upper and lower sides of the page and extending along the vertical sides of the page by a rotation angle θ from a reference position at which the horizontal direction of the page is parallel to the horizontal direction of the display region, and the page is looked down (viewed overhead) at an overhead angle φ from a viewpoint above the upper side of the page within the imaginary space. When the page is not rotated, the horizontal direction of the page is parallel to the horizontal direction of the display region, and the rotation angle θ is 0°. Moreover, the overhead angle φ is a predetermined angle. Furthermore, the rotation axis M is not limited to a configuration in which it is parallel to the vertical sides of the page but may be configured such that it crosses the horizontal sides of the page.

Specifically, first, the display image generation unit 1104 applies vertical modification to the front-view image of a page (FIG. 12B) supplied from the thumbnail generation unit 1102 without changing the horizontal width as shown in FIG. 12C and shifts the right side of the image of FIG. 12B by S·sin θ·tan φ in relation to the left side. Subsequently, the display image generation unit 1104 reduces the horizontal size of the image of FIG. 12C with a magnification of cos φ as shown in FIG. 12D. As a result, the horizontal width becomes S·cos θ. Lastly, the display image generation unit 1104 reduces the vertical size of the image of FIG. 12D with a magnification of cos φ as shown in FIG. 12E.

In this way, an image is obtained in which the page is rotated about the imaginary rotation axis M by the rotation angle θ and the page is looked down at the overhead angle φ from the viewpoint above the upper side of the page. The rotation angle is set to a predetermined rotation angle θ1 for the first selected page specified by the first selected page data, and is set to a predetermined rotation angle −θ1 for a page which is one page before the first selected page. Moreover, as for pages other than the first selected page, the rotation angle gradually increases as the difference in page number from the first selected page increases. In the present embodiment, the rotation angle for pages after the first selected page is in the range of θ1<θ<90°. In the present embodiment, the rotation angle for pages before the first selected page is in the range of −θ1>−−θ>−90°.

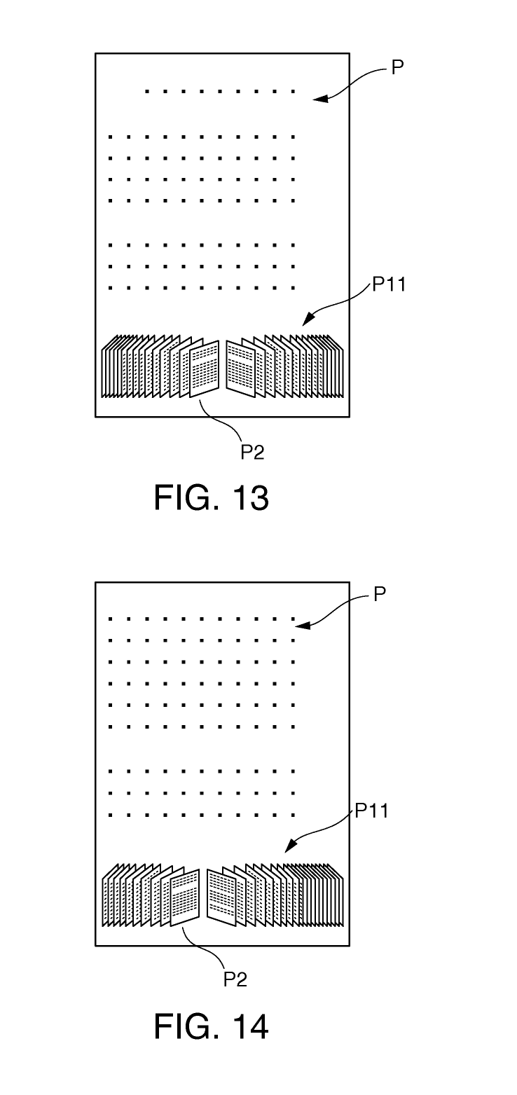

After modification of the thumbnail images is finished, the display image generation unit 1104 performs a display image generation step of generating images to be displayed on the display unit 1 (step S106). Specifically, as shown in FIG. 13, the display image generation unit 1104 generates an image in which the supplied first selected image P is arranged in the entire display region and the modified thumbnail images P11 are arranged under the first selected image P in an overlapped manner in ascending order of a page number from the right to the left of the display region. In FIG. 13, characters described in each page of the image are depicted by “•” for the sake of brevity. Moreover, among the thumbnail images P11, a thumbnail image of the first selected page is a thumbnail image P2. Here, the display image generation unit 1104 arranges the modified thumbnail images so that as shown in FIG. 13, the thumbnail images partially overlap with adjacent thumbnail images, and the gap between thumbnail images decreases as the distance to the thumbnail image of the first selected page increases. Moreover, the thumbnail image of the first selected page and the thumbnail image of a page which is one page before the first selected page are arranged so that the entire surfaces of the pages are viewable. Furthermore, the display image generation unit 1104 increases the gap between the thumbnail image of the second selected page and the thumbnail images of pages which are before and after the second selected page so that the content of the thumbnail image of a page represented by the second selected page data can be browsed. When the first and second selected pages are the same, the display image generation unit 1104 generates the image as shown in FIG. 13 without increasing the gap between the second selected page and the pages which are before and after the second selected page.

After generating the image including the image of the first selected page and the thumbnail images, the display image generation unit 1104 supplies the generated image to the controller 2. The controller 2 enters a display step of displaying the image and controls the display unit 1 so that the supplied image is displayed. In this way, the display unit 1 displays the image shown in FIG. 13 (step S107). When the image shown in FIG. 13 is displayed, since the first selected page is displayed on the entire display region of the display unit 1, the user can read the first selected page. Moreover, since pages other than the first selected page are displayed as thumbnail images, the user can understand the outlines of the respective pages. Furthermore, since the thumbnail images are displayed with the first selected page open as in the case of a paper book, the user can understand the page of the ebook that the user is reading.

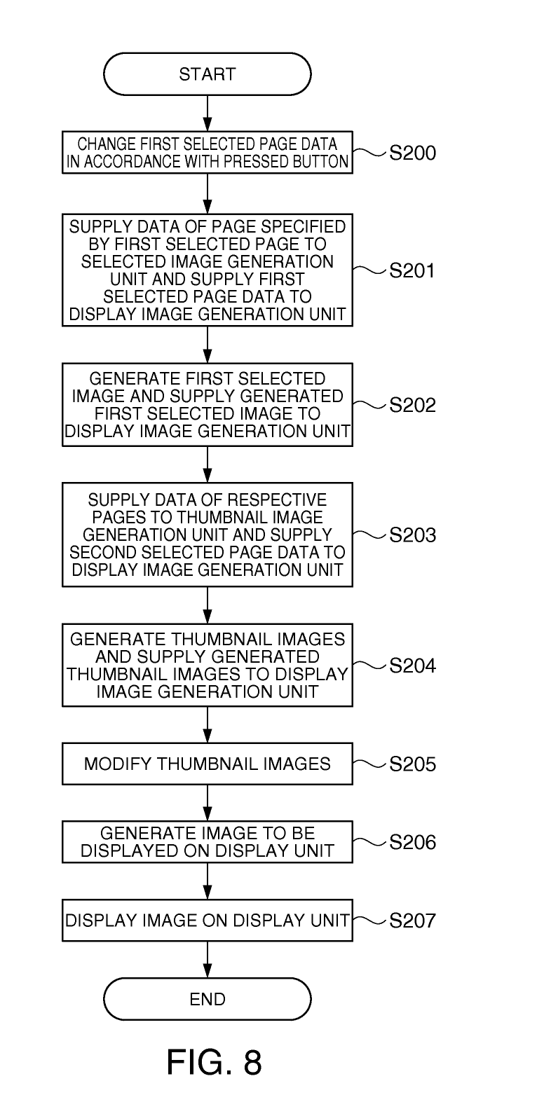

Subsequently, the operation when forward and backward scrolling of ebook pages are performed will be described. The display control unit 1101 adds “1” to the value of the first selected page data when the button 9F is pressed and subtracts “1” from the value of the first selected page data when the button 9E is pressed (FIG. 8: step S200). After changing the value of the first selected page data, the display control unit 1101 extracts the data of a page specified by the changed first selected page data from the document data, supplies the extracted data to the selected image generation unit 1103, and supplies the first selected page data to the display image generation unit 1104 (step S201).

For example, page 16 is the first selected page in FIG. 13. When the button 9F is pressed in this state so that the first selected page is changed to page 21, the display control unit 1101 extracts the data of page 21 from the document data and supplies the extracted data to the selected image generation unit 1103. Upon receiving the data of page 21, the selected image generation unit 1103 generates an image of page 21 based on the supplied data and supplies the generated image to the display image generation unit 1104 (step S202).

Moreover, the display control unit 1101 supplies the data of the respective pages of the document represented by the document data to the thumbnail generation unit 1102 and supplies the second selected page data to the display image generation unit 1104 (step S203). The thumbnail generation unit 1102 generates thumbnail images of the respective pages represented by the supplied data and supplies the generated thumbnail images to the display image generation unit 1104 (step S204). The display image generation unit 1104 modifies the supplied thumbnail images to generate an image in which the rotation angle is set to θ1 for the thumbnail image of page 21 specified by the first selected page data and generates an image in which the rotation angle is set to −θ1 for the thumbnail image of page 20. Moreover, the display image generation unit 1104 generates thumbnail images of pages other than the first selected page so that the rotation angle gradually increases as the distance from page 21 increases (step S205).

When the display image generation unit 1104 generates an image including the image of the first selected page and the modified thumbnail images (step S206) and supplies the generated image to the controller 2, an image in which the thumbnail image of page 21 is displayed with the rotation angle θ1 is displayed on the display unit 1 as shown in FIG. 14 (step S207).

Moreover, when the button 9E is pressed in the state shown in FIG. 13, and the first selected page is changed to page 11, the display control unit 1101 extracts the data of page 11 from the document data and supplies the extracted data to the selected image generation unit 1103. Upon receiving the data of page 11, the selected image generation unit 1103 generates an image of page 11 based on the supplied data and supplies the generated image to the display image generation unit 1104. Moreover, the display image generation unit 1104 generates an image in which the rotation angle is set to θ1 for the thumbnail image of page 11 and generates an image in which the rotation angle is set to −θ1 for the thumbnail image of page 10. Moreover, the display image generation unit 1104 generates thumbnail images of pages other than the first selected page so that the rotation angle gradually increases as the distance from page 11 increases.

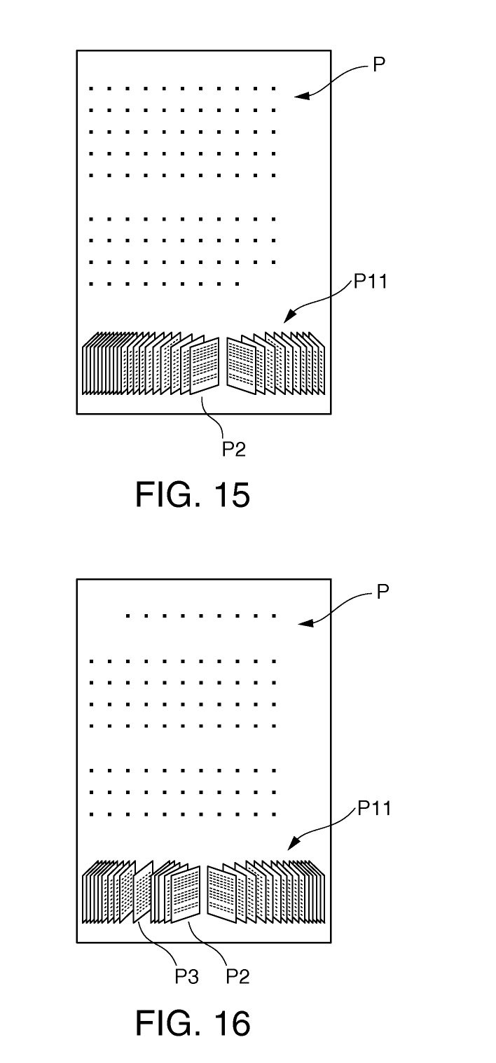

When the display image generation unit 1104 generates an image including the image of the first selected page and the modified thumbnail images and supplies the generated image to the controller 2, an image in which the thumbnail image of page 11 is displayed with the rotation angle θ1 is displayed on the display unit 1 as shown in FIG. 15. As above, when the first selected page is changed, the thumbnail images are also changed, and the user can easily understand the page of the ebook that the user is selecting.

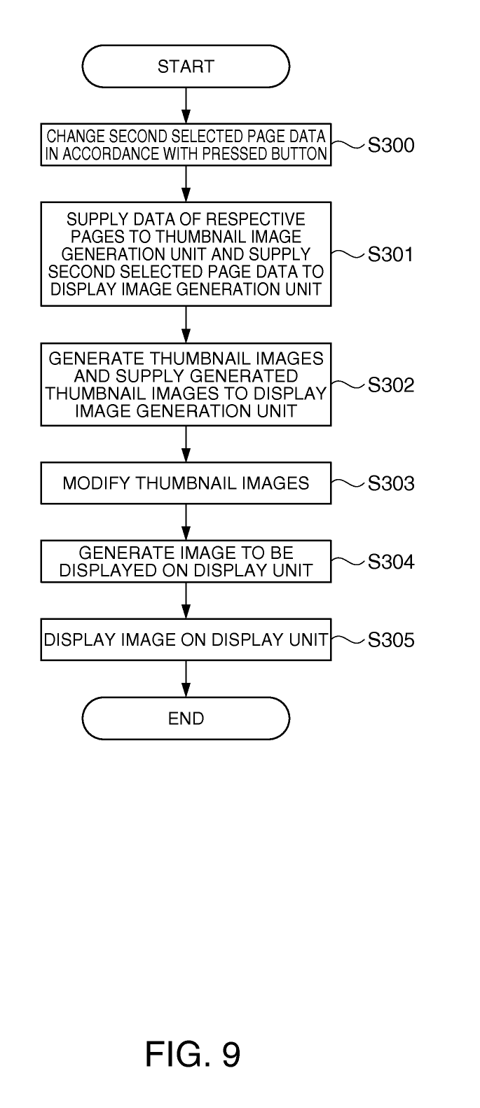

Next, the operation when forward and backward scrolling of the second selected page are performed will be described. The display control unit 1101 adds “1” to the value of the second selected page data when the button 9D is pressed in a state where the thumbnail images are displayed and subtracts “1” from the value of the second selected page data when the button 9C is pressed (FIG. 9: step S301). After changing the value of the second selected page data, the display control unit 1101 supplies the data of respective pages of the ebook represented by the document data to the thumbnail generation unit 1102 and supplies the second selected page data to the display image generation unit 1104 (step S301).

The thumbnail generation unit 1102 generates thumbnail images of the respective pages represented by the supplied data and supplies the generated thumbnail images to the display image generation unit 1104 (step S302). The display image generation unit 1104 modifies the supplied thumbnail images (step S303).

For example, when the button 9D is pressed in the state shown in FIG. 13 so that the second selected page is changed to page 21, the second selected page data having the value of “21” is supplied from the display control unit 1101 to the display image generation unit 1104. Upon receiving the second selected page data having the value of “21,” the display image generation unit 1104 arranges the thumbnail images by increasing the gaps between page 21 and page 20 and between page 21 and page 22 so that the content of the thumbnail image of page 21 can be browsed. When the display image generation unit 1104 generates an image including the image of the first selected page and the thumbnail images (step S304) and supplies the generated image to the controller 2, an image in which the gap between the thumbnail image P3 of page 21 which is the second selected page and thumbnail images of pages which are before and after page 21 is increased is displayed on the display unit 1 as shown in FIG. 16 (step S305).

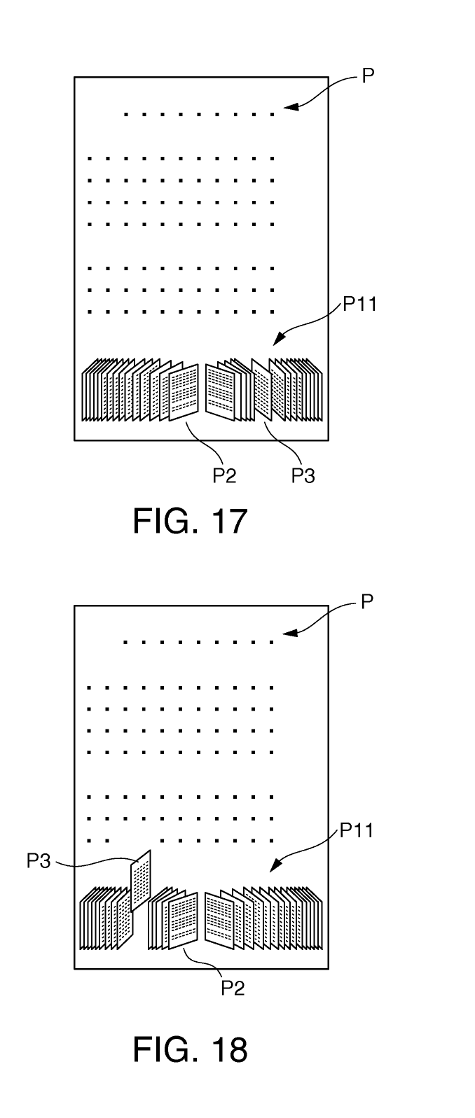

Moreover, when the button 9D is pressed in the state shown in FIG. 13 so that the second selected page is changed to page 10, the second selected page data having the value of “10” is supplied from the display control unit 1101 to the display image generation unit 1104. Upon receiving the second selected page data having the value of “10,” the display image generation unit 1104 arranges the thumbnail images by increasing the gaps between page 10 and page 11 and between page 10 and page 9 so that the content of the thumbnail image of page 10 can be browsed. When the display image generation unit 1104 generates an image including the image of the first selected page and the thumbnail images and supplies the generated image to the controller 2, an image in which the gap between the thumbnail image of page 10 and thumbnail images of pages which are before and after page 10 is increased is displayed on the display unit 1 as shown in FIG. 17.

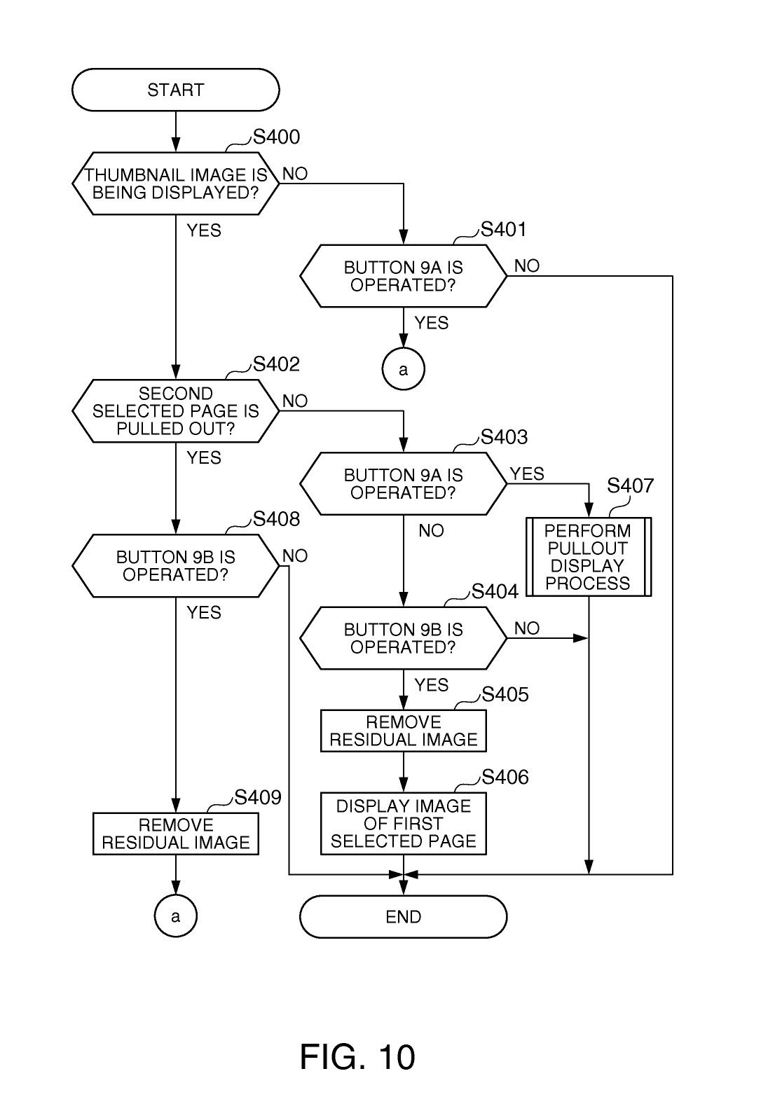

Next, FIG. 10 is a flowchart showing the flow of processes when the button 9A or 9B is operated. Hereinafter, the operation when the button 9A or 9B is operated will be described with reference to FIG. 10.

When the button 9A or 9B is operated, the display control unit 1101 determines whether a thumbnail image is being displayed. Here, when the thumbnail images P11 are not displayed on the display unit 1 (step S400: NO), the display control unit 1101 determines whether the operated button is the button 9A. When the operated button is a button other than the button 9A (step S401: NO), the display control unit 1101 ends the process shown in FIG. 10. On the other hand, when the operated button is the button 9A (step S401: YES), the flow of process in the electronic apparatus 1000 proceeds to step S101 of FIG. 7, and the selected image P and the thumbnail images P11 are displayed.

Moreover, when a determination result of YES is obtained in step S400, the display control unit 1101 determines whether a display (hereinafter, referred to as a pullout display) wherein the display position of the thumbnail image P3 of the second selected page is pulled out from the thumbnail images P11 is realized. Here, when a pullout display is not realized in the display unit 1 (step S402: NO), the display control unit 1101 determines whether the operated button is the button 9A. When the operated button is the button 9A (step S403: YES), the electronic apparatus 1000 performs the pullout display (step S407).

Specifically, the display control unit 1101 extracts the data of a page specified by the first selected page data from the document data, supplies the extracted data to the selected image generation unit 1103, and supplies the first selected page data to the display image generation unit 1104 (step S500). The selected image generation unit 1103 generates an image of the page indicated by the supplied data and supplies the generated first selected image to the display image generation unit 1104 (step S501). Moreover, the display control unit 1101 supplies the data of the respective pages of the document represented by the document data to the thumbnail generation unit 1102 and supplies the second selected page data and a pullout flag instructing the pullout display to the display image generation unit 1104 (step S502). The thumbnail generation unit 1102 generates thumbnail images of respective pages represented by the supplied data and supplies the generated thumbnail images to the display image generation unit 1104 (step S503). The display image generation unit 1104 modifies the supplied thumbnail images (step S504).

Subsequently, the display image generation unit 1104 generates an image including the image of the first selected page and the modified thumbnail images (step S505). Here, since the pullout flag is supplied from the display control unit 1101, the display image generation unit 1104 generates the image so that the display position of the thumbnail image P3 of the second selected page is shifted upward from the thumbnail images P11. When the display image generation unit 1104 supplies the generated image to the controller 2, as shown in FIG. 18, an image in which the thumbnail image P3 of the second selected page is shifted upward from the thumbnail images P11 is displayed on the display unit 1 (step S506).

Moreover, when a determination result of NO is obtained in step S403, the display control unit 1101 determines whether the operated button is the button 9B. Here, when the operated button is a button other than the button 9B (step S404: NO), the display control unit 1101 ends the process shown in FIG. 10. On the other hand, when the operated button is the button 9B (step S404: YES), the thumbnail images P11 are removed, and only the selected image P is displayed. Specifically, the display control unit 1101 performs a residual image removal process of removing a residual image present on the display region 55 (step S405). Here, the residual image removal process in the present embodiment is a process of changing the gradation of all pixels to the same gradation so that all pixels are first changed to black and then to white. When the display control unit 1101 instructs the residual image removal process to the display image generation unit 1104, first, the residual image removal unit 1104A of the display image generation unit 1104 generates an entirely black image so that all the pixels of the display region 55 are changed to black and supplies the generated image to the controller 2. In this way, all pixels are first changed to black. Subsequently, the residual image removal unit 1104A of the display image generation unit 1104 generates an entirely white image so that all the pixels of the display region 55 are changed to white and supplies the generated image to the controller 2. In this way, all the pixels are changed to white. By this residual image removal process, black electrophoretic particles in the entire display region 55 are moved toward the pixel electrodes 13a, whereby no residual image may remain when displaying the next image.

Subsequently, the display control unit 1101 extracts the data of a page specified by the first selected page data from the document data, supplies the extracted data to the selected image generation unit 1103, and supplies the first selected page data to the display image generation unit 1104. The selected image generation unit 1103 generates an image of the page indicated by the supplied data and supplies the generated first selected image to the display image generation unit 1104. Subsequently, the display control unit 1101 instructs the display image generation unit 1104 to display the first selected page. In this way, the thumbnail images P11 are removed, and only the selected image P of the first selected page is displayed on the display unit 1.

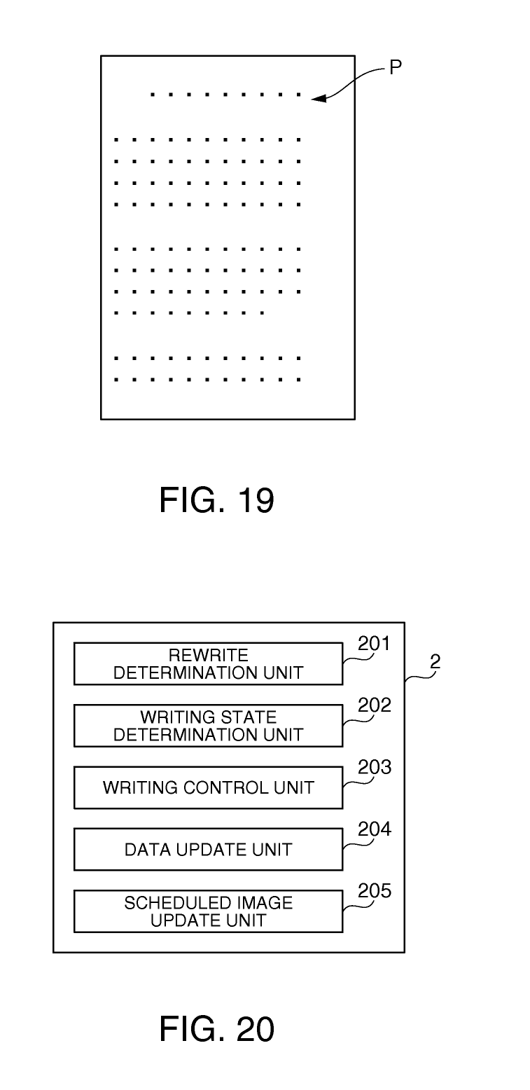

For example, when the button 9B is operated in a state where the display unit 1 is in the state shown in FIG. 13, the thumbnail images P11 are removed, and the state shown in FIG. 19 is created in the display unit 1. When the residual image removal process is not performed when removing the thumbnail images P11, the residual image of the thumbnail images P11 may remain at the position where the thumbnail images P11 were displayed in FIG. 13. On the other hand, in the present embodiment, since all the pixels are first changed to black and then to white before the thumbnail images P11 are removed, no residual image of the thumbnail images P11 will remain when the thumbnail images P11 are removed and only the selected image P is displayed.

Moreover, when a determination result of YES is obtained in step S402, the display control unit 1101 determines whether the operated button is the button 9B. Here, the operated button is a button other than the button 9B (step S408: NO), the display control unit 1101 ends the process shown in FIG. 10. On the other hand, when the operated button is the button 9B (step S408: YES), the display in which the position of the thumbnail image P3 which is pulled out is returned to the position of the thumbnail images P11 is performed. Specifically, first, the display control unit 1101 performs the residual image removal process (step S409). The process performed in step S409 is the same as the process performed in step S405. When the process of step S409 ends, the flow of processes proceeds to step S101 of FIG. 7, and the selected image P and the thumbnail images P11 are displayed. For example, when the button 9B is operated in a state where the display unit 1 is in the state shown in FIG. 18, the state shown in FIG. 13 is created in the display unit 1.

When the residual image removal process is not performed when the display state is changed from that of FIG. 18 to that of FIG. 13, the residual image of the thumbnail image P3 remains at the position where the thumbnail image P3 was displayed in FIG. 18. On the other hand, in the present embodiment, since all the pixels are first changed to black and then to white before the thumbnail image P3 is returned to the thumbnail images P11, the residual image of the thumbnail image P3 may not remain when the thumbnail image P3 is returned to the thumbnail images P11.

Next, a characteristic configuration that controls the display unit 1 of the present embodiment will be described. In the present embodiment, when changing the display states of the respective pixels from white (low-density) to black (high-density) or from black to white, rather than changing the display states by driving the pixel driving circuits for only one frame, the display states are changed by a writing operation of applying a voltage to the pixels over a plurality of frames. This is because even if a potential difference is applied to electrophoretic particles for only one frame when changing the display state from white to black, the black electrophoretic particles do not completely move to the display side, and a perfect black display state is not realized. The same occurs to white electrophoretic particles when changing the display state from black to white. Therefore, for example, when changing the display states of pixels from white to black, a data signal for causing pixels to appear black is supplied to the pixel driving circuits over a plurality of frames. Moreover, when changing the display states of the pixels from black to white, a data signal for causing the pixels to appear white is supplied to the pixel driving circuits over a plurality of frames.

FIG. 20 is a block diagram showing the functions related to displaying of images, of the controller 2 controlling the display unit 1. The controller 2 includes a rewrite determination unit 201, a writing state determination unit 202, a writing control unit 203, a data update unit 204, and a scheduled image update unit 205. These respective blocks may be realized by hardware, and the respective blocks may be realized by providing a CPU in the controller 2 and causing the CPU to execute programs. In the present embodiment, the RAM 5 includes a writing data storage area 6 and a scheduled image data storage area 7.

The rewrite determination unit 201 is a block that compares image data stored in the VRAM 4 with image data stored in the scheduled image data storage area 7 to determine whether the two data are different or not. The writing state determination unit 202 is a block that determines whether a rewrite operation for changing the display states of the pixels from black to white or from white to black is progressing by referring to the data stored in the writing data storage area 6. The writing data storage area 6 includes a white writing data storage area 6A that stores data (first writing data) representing whether an operation of changing the display states of the respective pixels from black to white is progressing and a black writing data storage area 6B that stores data (second writing data) representing whether an operation of changing the display states of the respective pixels from white to black is progressing.

The writing control unit 203 is a block that controls the scanning line driving circuit 53 and the data line driving circuit 54 so that a data signal is supplied to the pixel electrodes 13a. The data update unit 204 is a block that writes data to the white writing data storage area 6A and the black writing data storage area 6B. The scheduled image update unit 205 is a block that overwrites the image data stored in the scheduled image data storage area 7 with the image data stored in the VRAM 4.

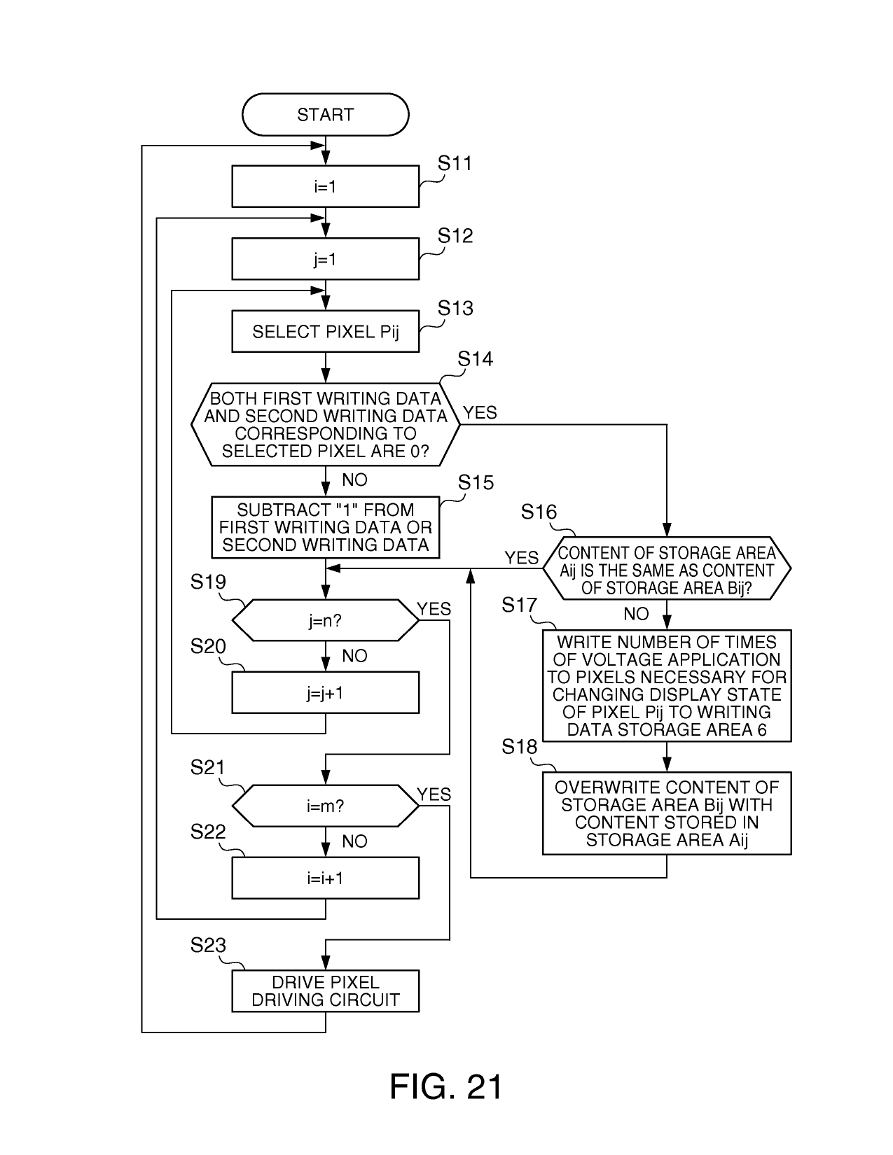

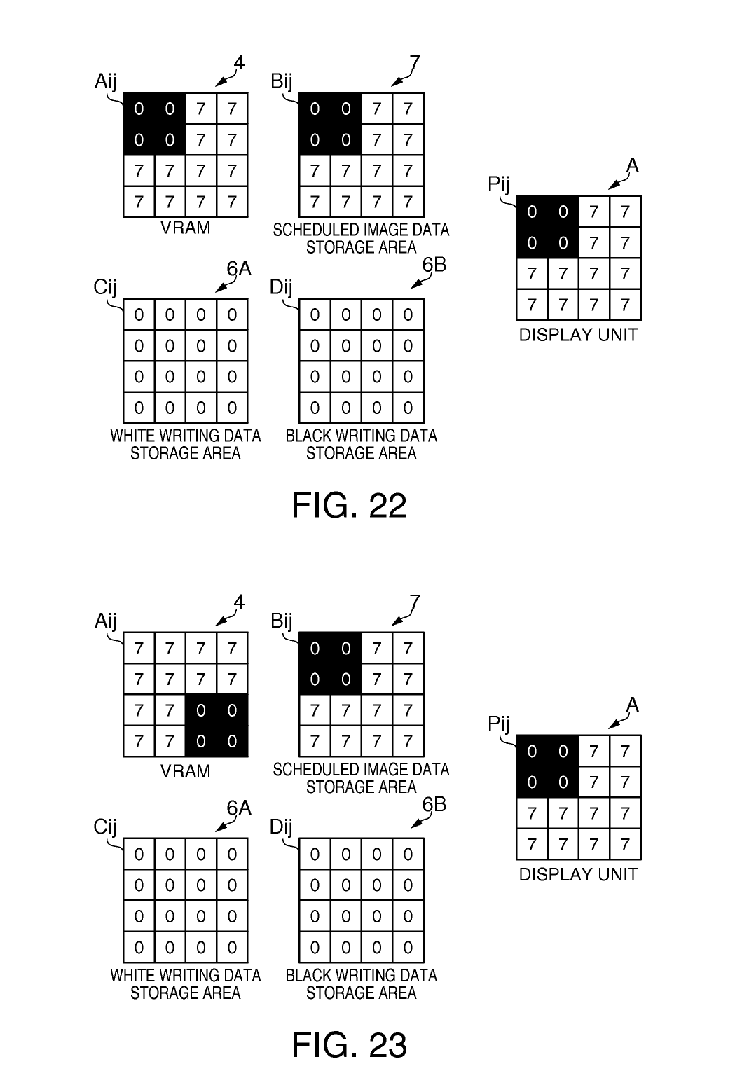

Next, an image rewrite operation will be described with reference to FIGS. 21 to 37. In FIGS. 22 to 37, an image A represents an image displayed on the display unit 1. Moreover, a pixel Pij represents one pixel. Here, the subscripts i and j represent row and column numbers of the pixel in a matrix. Hereinafter, when describing a specific pixel, a pixel on the first row and first column will be referred to as a pixel P11. In the image A, gradations of 8 steps of black to white are represented by the numbers 0 to 7 so that the gradations of the respective pixels can be easily understood. However, in practice, this number is not displayed. Moreover, in the display unit 1, although pixels are present at every intersection between m scanning lines 64 and n data lines 65, only 4 by 4 pixels P11 to P44 in a part of the display unit 1 are illustrated in FIGS. 22 to 37 for the sake of brevity.

Moreover, in FIGS. 22 to 37, the content of a storage area Aij corresponding to the pixels P11 to P44 in the VRAM 4, the content of a storage area Bij corresponding to the pixels P11 to P44 in the scheduled image data storage area 7, the content of a storage area Cij corresponding to the pixels P11 to P44 in the white writing data storage area 6A, and the content of a storage area Dij corresponding to the pixels P11 to P44 in the black writing data storage area 6B are illustrated. The subscripts i and j of the respective storage areas represent the row and column numbers of the storage area in a matrix. For example, when describing a specific storage area, a storage area Aij on the first row and first column will be referred to as a storage area A11.

The gradations of the respective pixels of an image displayed on the display unit 1 are stored in the storage areas A11 to A44 of the VRAM 4, and the gradations of the respective pixels of an image scheduled to be displayed on the display unit 1 are stored in the storage areas B11 to B44 of the scheduled image data storage area 7. The number of times of voltage application necessary for changing the display states of the pixels P11 to P44 to white is stored in the storage areas C11 to C44 of the white writing data storage area 6A as first writing data. The number of times of voltage application necessary for changing the display states of the pixels P11 to P44 to black is stored in the storage areas D11 to D44 of the black writing data storage area 6B as second writing data. When the first and second writing data are not 0, it means the pixel rewrite operation is progressing. When the first and second writing data are 0, it means the pixel rewrite operation is finished.

The controller 2 performs processes shown in FIG. 21 when driving pixels. First, the writing state determination unit 202 initializes the value of variables i and j to “1” (steps S11 and S12). Subsequently, the writing state determination unit 202 selects a pixel Pij specified by the variables i and j (step S13). For example, when the values of the variables i and j are 1 and 1, respectively, the pixel P11 is selected.

Subsequently, the writing state determination unit 202 determines whether both the first writing data stored in the storage area Cij corresponding to the selected pixel Pij and the second writing data stored in the storage area Dij are 0 (step S14). When both the first writing data stored in the storage area Cij corresponding to the selected pixel Pij and the second writing data stored in the storage area Dij are 0 (step S14: YES), the writing state determination unit 202 proceeds to step S16. When any one of the first and second writing data is not 0 (step S14: NO), the writing state determination unit 202 proceeds to step S15. In step S15, the data update unit 204 subtracts “1” from the data having a value other than 0 among the first writing data stored in the storage area Cij and the second writing data stored in the storage area Dij. The subtraction of “1” is not performed with respect to the first or second writing data having the value of 0.

On the other hand, in step S16, in order to determine whether the gradation is changed or not, the rewrite determination unit 201 compares the data stored in the storage area Aij with the data stored in the storage area Bij. Here, when both data are different (step S16: NO), the rewrite determination unit 201 performs a data update step of specifying the pixel Pij as a pixel of which the display state is to be newly changed (specifying step) and updating the data associated with the specified pixel Pij.

In the data update step, the data update unit 204 writes the number of times of voltage application to the pixels necessary for changing the gradation of the pixel Pij to the gradation of the storage area Aij in the writing data storage area 6 (step S17). Moreover, the scheduled image update unit 205 overwrites the content of the storage area Bij with the content stored in the storage area Aij (step S18).

Subsequently, in step S19, the controller 2 determines whether the value of the variable j is the same as the number n of data lines. Here, if the value of the variable j is not the same as n (step S19: NO), “1” is added to the value of the variable j (step S20), and the flow proceeds to step S13. When the value of the variable j is n, it is determined whether the value of the variable i is the same as the number m of scanning lines. Here, if the value of the variable i is not the same as m (step S21: NO), “1” is added to the value of the variable i (step S22), and the flow proceeds to step S12. When the value of the variable i is m (step S21: YES), the writing control unit 203 drives the pixel driving circuit by controlling the scanning line driving circuit 53 and the data line driving circuit 54 (step S23).

Next, a change in the display of the display unit 1, a change in the content of the VRAM 4, a change in the content of the scheduled image data storage area 7, and a change in the content of the writing data storage area 6 during a period after image data are written to the VRAM 4 and before an image of the image data is displayed on the display unit 1 will be described with reference to FIGS. 22 to 37.

In a state where the display of the display unit 1 and the states of the VRAM 4, the writing data storage area 6, and the scheduled image data storage area 7 are in the state shown in FIG. 22, when the control unit 3 writes image data to the VRAM 4 (data write step), the state of the VRAM 4 is changed to the state shown in FIG. 23 in accordance with the image data.

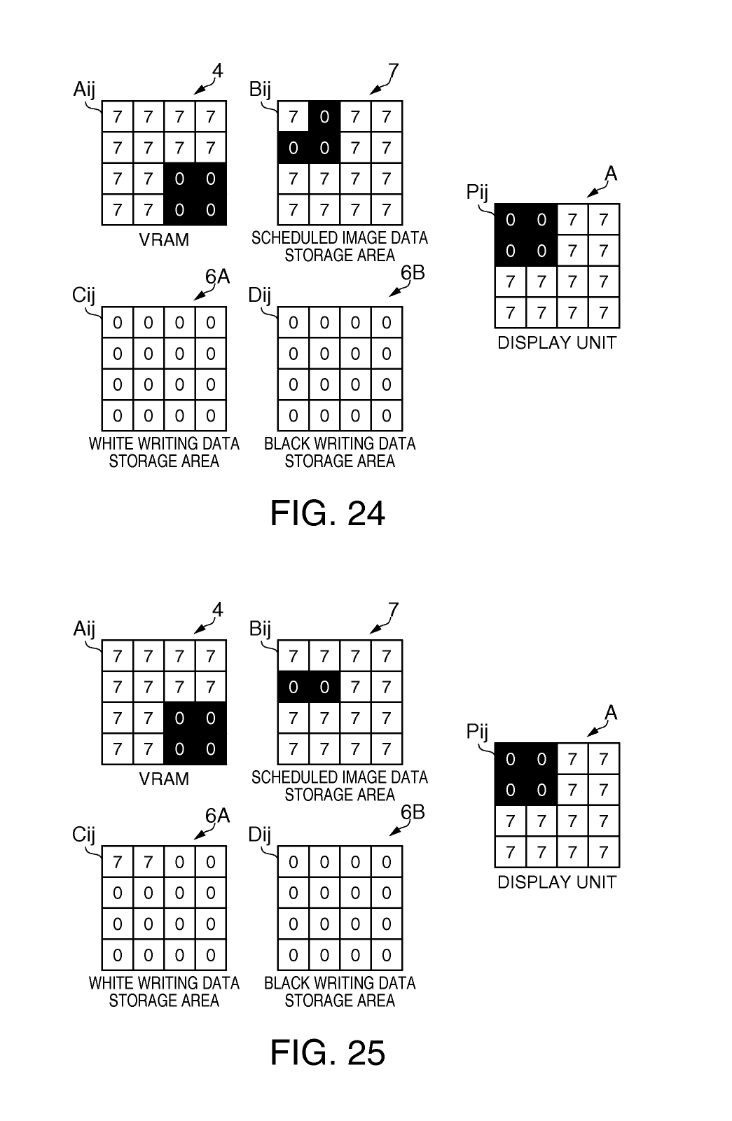

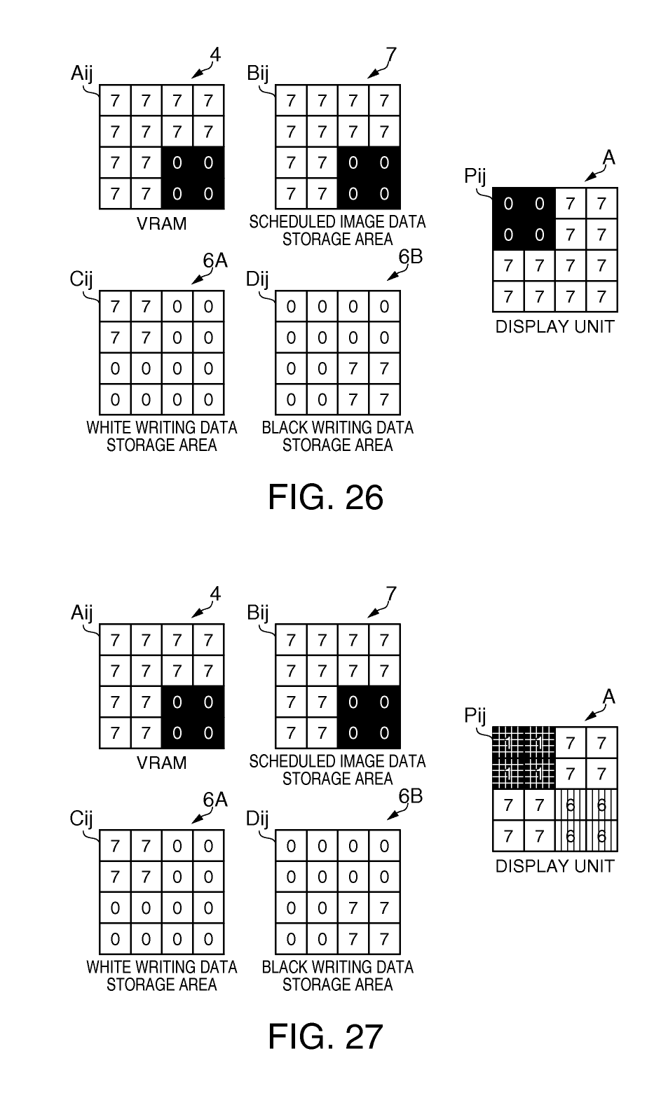

When the pixel P11 is selected in the state of FIG. 23 in step S13, a determination result of YES is obtained in step S14, and a determination result of NO is obtained in step S16. Since the content of the storage area B11 represents black and the content of the storage area A11 represents white, the pixel P11 is changed from black to white. Thus, “7” is written to the storage area C11 in step S17, and the content of the storage area A11 is written to the storage area B11 in step S18, whereby the state shown in FIG. 24 is created. Subsequently, when the pixel P12 is selected, a determination result of YES is obtained in step S14, and a determination result of NO is obtained in step S16. As a result, “7” is written to the storage area C12 in step S17, and the content of the storage area A12 is written to the storage area B12 in step S18, whereby the state shown in FIG. 25 is created. Moreover, when the pixel P33 is selected, a determination result of YES is obtained in step S14, and a determination result of NO is obtained in step S16. Since the content of the storage area B33 represents white and the content of the storage area A33 represents black, the pixel P33 is changed from white to black. Thus, “7” is written to the storage area D33 in step S17, and the content of the storage area A11 is written to the storage area B11 in step S18. After that, when the pixel P44 is selected, the content of the scheduled image data storage area 7 becomes the same as the content of the VRAM 4 as shown in FIG. 26. Moreover, in the white writing data storage area 6A, “7” is written to the storage areas C11, C12, C21, and C22. In the black writing data storage area 6B, “7” is written to the storage areas D33, D34, D43, and D44.

After that, when the process of step S23 is performed, since the content of the storage area C11 in a pixel driving circuit (a pixel driving circuit corresponding to the intersection between the first scanning line 64 and the first data line 65) corresponding to the pixel P11 is not “0,” a voltage is applied to the data line 65 such that when the scanning line 64 is selected, the potential of the pixel electrode 13a is −15 V in relation to the potential Vcom of the transparent electrode layer 32. Moreover, the contents of the storage areas C12, C21, and C22 in the pixel driving circuits corresponding to the pixels P12, P21, and P22 are not “0,” a voltage is applied to the data line 65 such that when the scanning line 64 is selected, the potential of the pixel electrode 13a is −15 V in relation to the potential Vcom of the transparent electrode layer 32.

Moreover, since the content of the storage area D33 in a pixel driving circuit (a pixel driving circuit corresponding to the intersection between the third scanning line 64 and the third data line 65) corresponding to the pixel P33 is not “0,” a voltage is applied to the data line 65 such that when the scanning line 64 is selected, the potential of the pixel electrode 13a is +15 V in relation to the potential Vcom of the transparent electrode layer 32. Moreover, the contents of the storage areas D34, D43, and D44 in the pixel driving circuits corresponding to the pixels P34, P43, and P44 are not “0,” a voltage is applied to the data line 65 such that when the scanning line 64 is selected, the potential of the pixel electrode 13a is +15 V in relation to the potential Vcom of the transparent electrode layer 32.

For other pixels, since the contents of the corresponding storage areas in the white writing data storage area 6A are “0” and the contents of the corresponding storage areas in the black writing data storage area 6B are “0,” a voltage is applied to the data line 65 such that when the scanning line 64 is selected, the potential of the pixel electrode 13a is 0 V in relation to the potential Vcom of the transparent electrode layer 32. When the voltage is applied to the data line 65 in this way, white and black particles in the pixels move whereby the state shown in FIG. 27 is created in the display of the display unit 1.

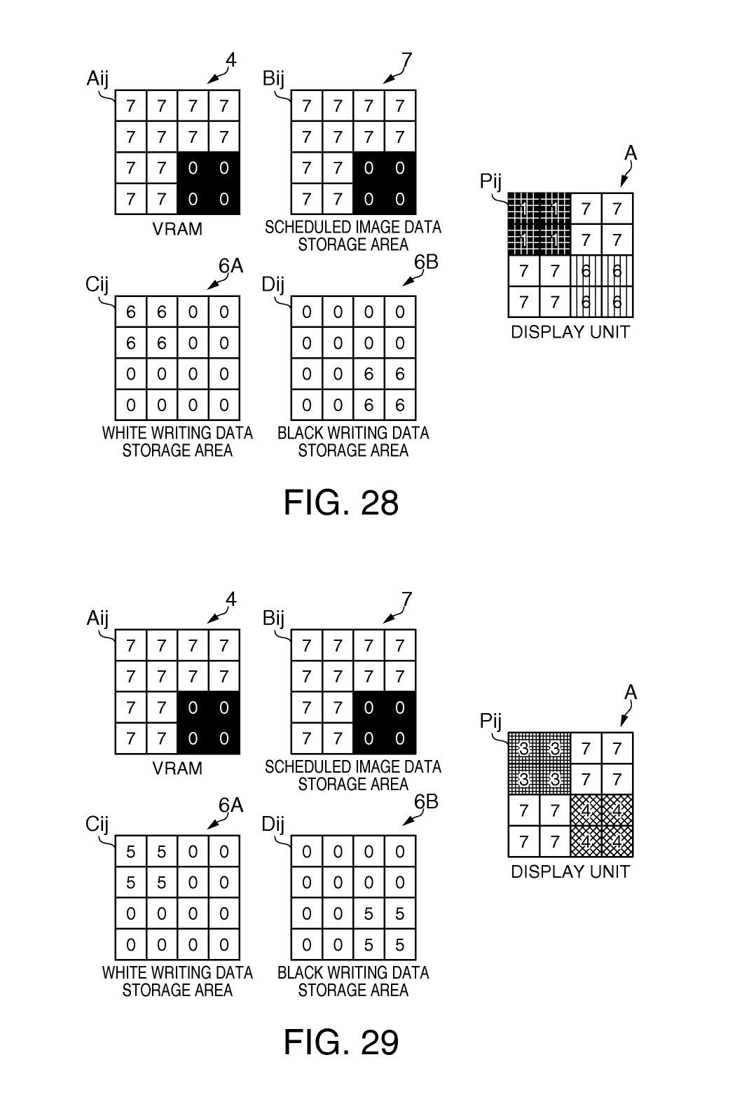

When the process of step S23 is finished, the controller 2 returns the flow of processes to step S11. When the pixel P11 is selected in the state of FIG. 27 in step S13, a determination result of NO is obtained in step S14, and “1” is subtracted from the value written in the storage area C11, so that the content of the storage area C11 is changed to “6”. Subsequently, when the pixel P12 is selected, a determination result of NO is obtained in step S14, and “1” is subtracted from the value written in the storage area C12, so that the content of the storage area C12 is changed to “6”. After that, when the pixel P44 is selected, the contents of the storage areas C11, C12, C21, and C22 are changed to “6” and the contents of the storage areas D33, D34, D43, and D44 are changed to “6” as shown in FIG. 28.

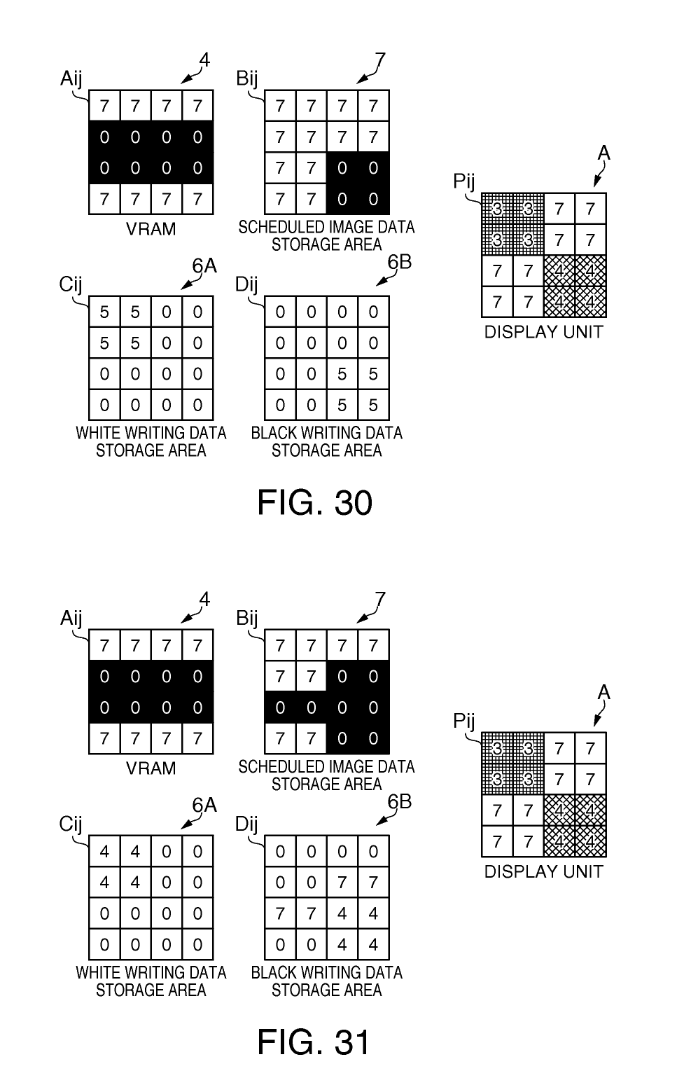

FIG. 29 is a diagram showing the state immediately after the process of step S23 is performed twice in the state shown in FIG. 28. Here, a case in which the content of the VRAM 4 is rewritten as shown in FIG. 30 will be considered. When the pixel P21 is selected in the state of FIG. 30 in step S13, a determination result of NO is obtained in step S14, and “1” is subtracted from the value written to the storage area C21 in step S15, so that the content of the storage area C21 is changed to “4”. On the other hand, when the pixel P23 is selected in step S13, a determination result of YES is obtained in step S14, and a determination result of NO is obtained in step S16. As a result, “7” is written to the storage area D23 in step S17, and the content of the storage area A23 is written to the storage area B23 in step S18. As above, even when the content of the VRAM 4 is rewritten from white to black, rewriting to white progresses in the pixels in which rewriting to white is progressing, and the second writing data is stored in the black writing data storage area 6B with respect to the pixels which are not rewritten. Moreover, when the pixel P43 is selected in the state of FIG. 30 in step S13, a determination result of NO is obtained in step S14, and “1” is subtracted from the value written to the storage area D43 in step S15, so that the content of the storage area D43 is changed to “4”. As above, even when the content of the VRAM 4 is rewritten from black to white, rewriting progresses in the pixels in which rewriting to black is progressing.

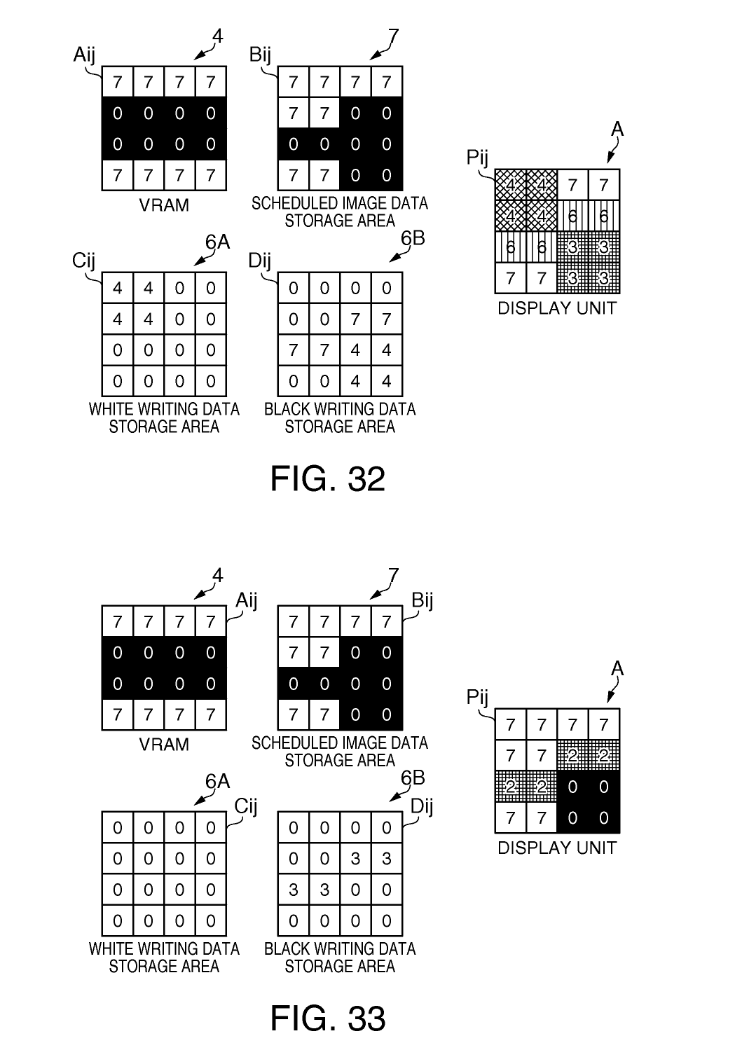

When processes are performed in the state of FIG. 30 until a determination result of YES is obtained in step S21, the state shown in FIG. 31 is created in the VRAM 4 and the respective storage areas. Moreover, when the process of step S23 is performed in the state shown in FIG. 31, the state shown in FIG. 32 is created in the display unit 1. As for the pixels corresponding to portions of the VRAM 4 in which the contents are rewritten, rewriting progresses in the pixels in which rewriting is progressing, and pixel rewriting is newly started in the pixels which are not rewritten.

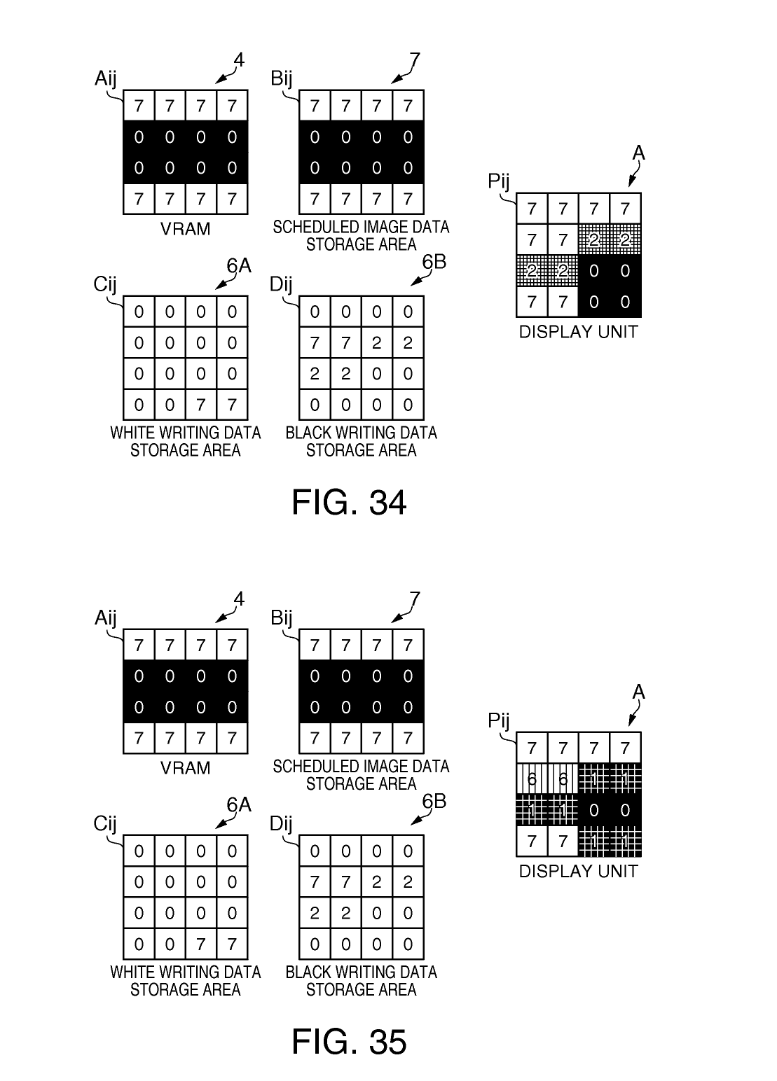

When the processes progress further and the values of the first and second writing data in the pixels in which rewriting has been started earlier become “0,” the state shown in FIG. 33 is created in the respective storage areas and the display unit 1. When the pixel P21 is selected in the state of FIG. 33 in step S13, a determination result of YES is obtained in step S14, and a determination result of NO is obtained in step S16. As a result, “7” is written to the storage area D21 in step S17, and the content of the storage area A21 is written to the storage area B21 in step S18. Moreover, when the pixel P41 is selected in step S13, a determination result of YES is obtained in step S14, and a determination result of NO is obtained in step S16. As a result, “7” is written to the storage area C41 in step S17, and the content of the storage area A41 is written to the storage area B41 in step S18. After that, when the processes are performed until a determination result of YES is obtained in step S21, the state shown in FIG. 34 is created in the respective storage areas, and the state shown in FIG. 35 is created when the process of step S23 is performed.

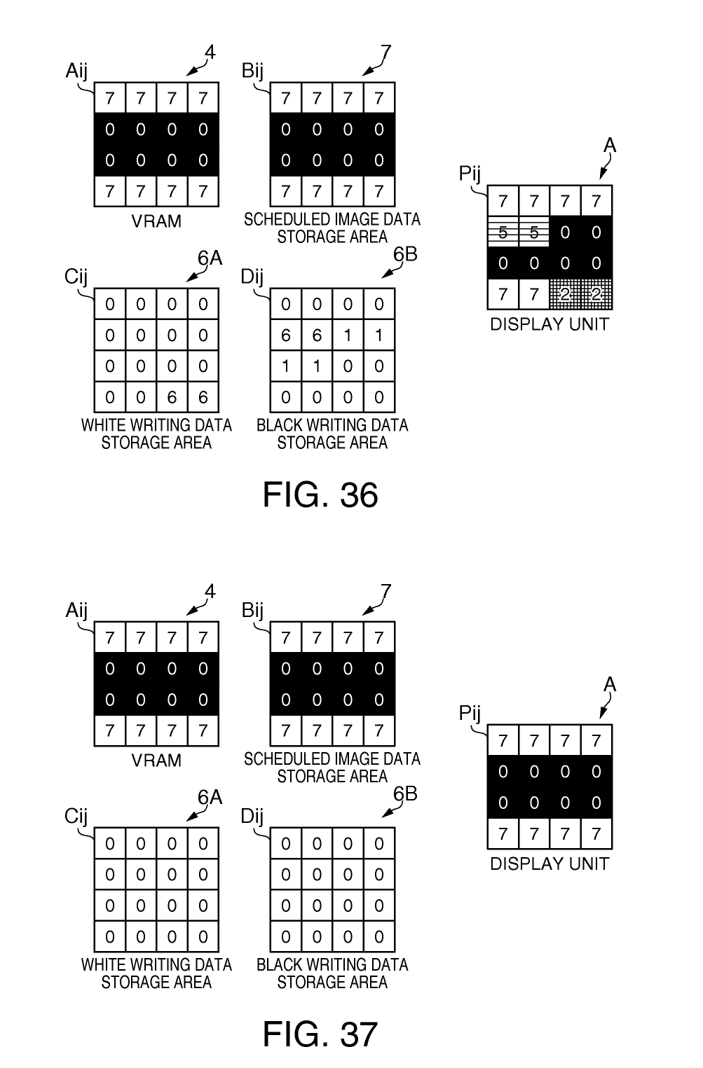

After that, when the processes progress, and the process of step S23 is performed in a state where the state of FIG. 36 is created in the respective storage areas, the state shown in FIG. 36 is created in the display unit 1, and rewriting of the pixels P23, P24, P31, and P32 is finished. Moreover, when the processes progress further, the rewriting of the pixels P21, P22, P43, and P44 progresses, and finally, the state shown in FIG. 37 is created.

According to the present embodiment, even when an area in which rewriting has been started earlier overlaps with an area in which new rewriting is performed, since rewriting is started immediately in portions in which rewriting is not progressing when new rewriting is started, the user may experience a faster display speed.

Moreover, in the present embodiment, the pixel electrodes 13a of the pixels within one frame can be used as a positive polarity such that they have higher potentials than the transparent electrode layer 32, and the pixel electrodes 13a of the other pixels within the same frame can be used as a negative polarity such that they have lower potentials than the transparent electrode layer 32. That is, the pixel electrodes can be driven so as to be selectively used as the positive and negative polarities in relation to the transparent electrode layer 32 within one frame (hereinafter, this driving method will be referred to as dual polarity driving). More specifically, within one frame, the pixel electrodes 13a of the pixels of which the gradations are changed toward the high density side are used as a positive polarity, and the pixel electrodes 13a of the pixels of which the gradations are changed toward the low density side are used as a negative polarity. When the black electrophoretic particles are negatively charged, and the white electrophoretic particles are positively charged, the pixel electrodes 13a of the pixels of which the gradations are changed toward the high density side may be used as a negative polarity, and the pixel electrodes 13a of the pixels of which the gradations are changed toward the low density side may be used as a positive polarity. Although the dual polarity driving method is used in the present embodiment, a single polarity driving method may also be used in which a voltage for causing pixels to appear white is applied to the pixels within one frame period, and a voltage for causing pixels to appear black is applied to the pixels within another one frame period.

### Modified Example

Although the embodiment of the invention has been described hereinabove, the invention is not limited to the above-described embodiment, but may be embodied in various other forms. For example, the invention may be embodied by modifying the above-described embodiment in the following manner. Moreover, the above-described embodiment and each of the following modified examples may be combined with each other.

In the invention, the electronic apparatus 1000 is not limited to an ebook reader but may be an electronic apparatus other than the ebook reader as long as the electronic apparatus includes an electrophoretic display unit. Moreover, in the invention, the display unit 1 is not limited to one using electrophoresis, but may be one using electronic liquid powder.

In the electronic apparatus other than the ebook reader, when displaying the image of the first selected page of an ebook and the thumbnail images, a program realizing the display control unit 1101, the thumbnail generation unit 1102, the selected image generation unit 1103, and the display image generation unit 1104 shown in FIG. 6 is installed and the program is executed, whereby the image of the first selected page of the ebook and the thumbnail images are displayed.

The program may be provided in a state of being stored in a computer-readable recording medium such as a magnetic recording medium (magnetic tape, magnetic disk (HDD (Hard Disk Drive), FD (Flexible Disk)), and the like), an optical recording medium (optical disc (CD (Compact Disc)), DVD (Digital Versatile Disc)), and the like), an opto-magnetic recording medium, or a semiconductor memory and may be installed in the electronic apparatus 1000. Moreover, the program may be downloaded through a communication line and installed in the electronic apparatus 1000.

Furthermore, in the invention, the image displayed on the display unit 1 is not limited to the image of an ebook but may be the image of a document such as a thesis, a report, or a material.

In the above-described embodiment, when document data is selected by the user, the image of the selected page and thumbnail images P11 are displayed first. However, in the invention, when document data is selected by the user and the image of the page is displayed first, only the selected image P may be displayed, and the thumbnail images P11 may not be displayed.

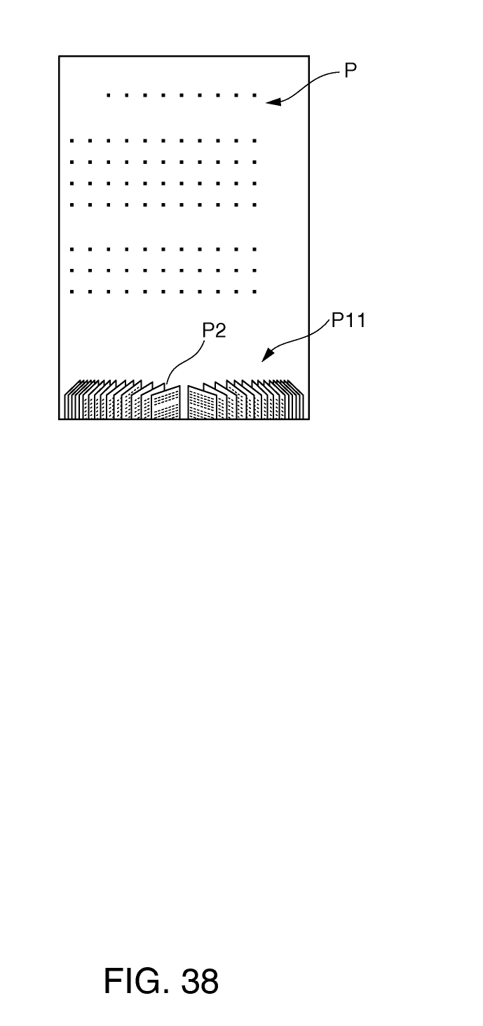

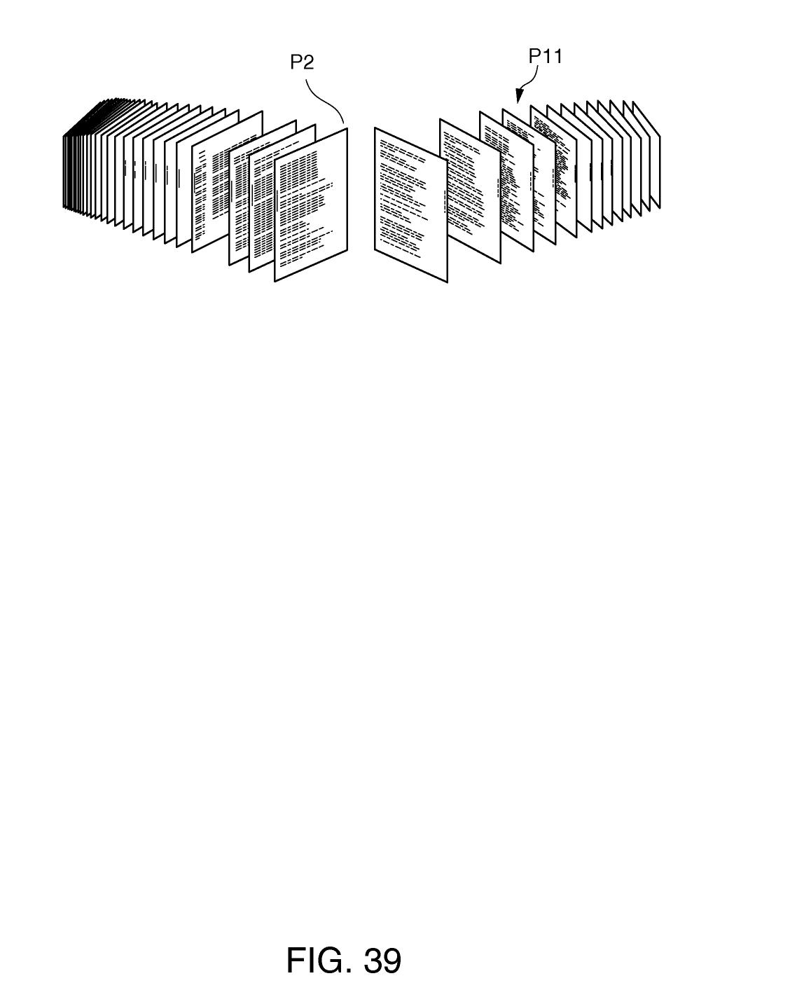

Furthermore, in the invention, the upper part of the thumbnail images, which is a predetermined range from the upper end of each page may be displayed as shown in FIG. 38, and the lower part lower than the upper part may not be displayed. Furthermore, in the invention, when increasing the gap between the thumbnail images, if the second selected page is after the first selected page, the gap between the thumbnail images of the pages before the second selected page may be increased whereas the gap between the thumbnail images of the pages after the second selected page may not be increased. If the second selected page is before the first selected page, the gap between the thumbnail images of the pages after the second selected page may be increased whereas the gap between the thumbnail images of the pages before the second selected page may not be increased. Furthermore, in the invention, the thumbnail images may be displayed so that the gap between the thumbnail images of the pages decreases as the distance from the thumbnail image P2 of the first selected page increases. Furthermore, in the above-described embodiment, although the thumbnail images are displayed so as to overlap with the adjacent thumbnail images, the thumbnail images of the pages in a predetermined range from the first selected page may be displayed so as not to overlap with each other.

In the invention, the thumbnail image size may be determined in advance, and the thumbnail image size may be changed in accordance with the operation of the user. Moreover, when the electronic apparatus 1000 is a personal computer, the personal computer may acquire the resolution of a display device displaying images and change the thumbnail image size in accordance with the acquired resolution. Furthermore, in the invention, the thumbnail image of the first selected page may have a larger size than the thumbnail images of the pages other than the first selected page. Furthermore, in the invention, the thumbnail image of the second selected page may also have a larger size than the thumbnail images of the pages which are before and after the second selected page. Furthermore, in the invention, the thumbnail image of the first selected page may have the largest size, and the thumbnail image size may decrease as the distance from the first selected page increases. Furthermore, in the invention, the thumbnail images of the pages within a predetermined range from the first selected page may have the same size as the first selected page, and the thumbnail images of the pages outside the range may have a smaller size than the thumbnail image of the first selected page.

In the above-described embodiment, the thumbnail images have been arranged in ascending order of page number from the right to the left of the display region. However, in the invention, the thumbnail images may be arranged in descending order of page number from the right to the left of the display region. Moreover, in the invention, as shown in FIG. 39, the thumbnail images displayed on the left side of the thumbnail image of the first selected page may be displayed so as to be inclined upward as the distance from the first selected page increases. Moreover, the thumbnail images displayed on the right side of the thumbnail image of a page which is one page before the first selected page may be displayed so as to be inclined upward as the distance from the thumbnail image of the page which is one page before the first selected page increases.

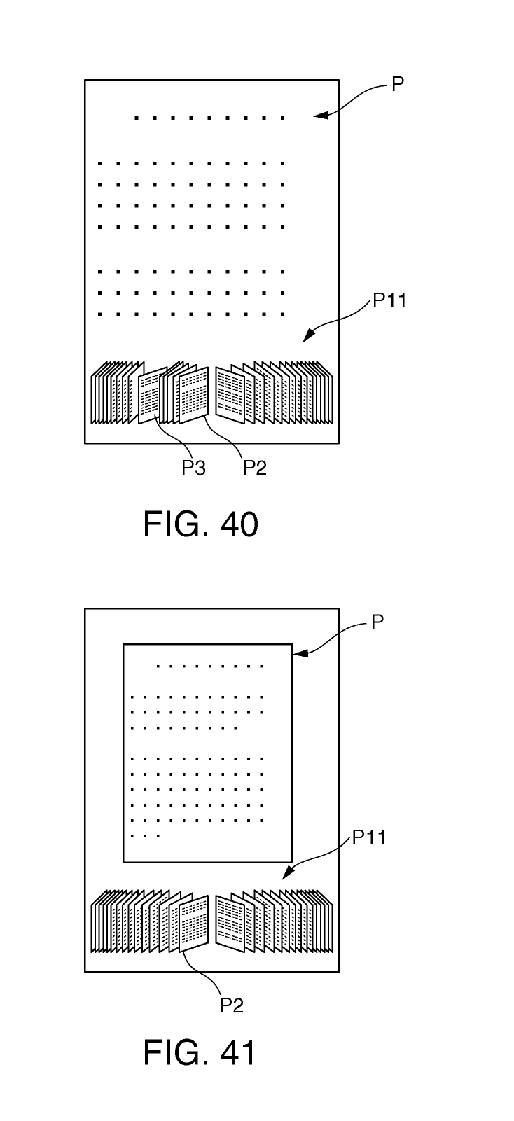

In the invention, the thumbnail image of the second selected page may have a smaller rotation angle than the thumbnail images of pages which are before and after the second selected page as shown in FIG. 40. Moreover, in the above-described embodiment, the thumbnail images of the pages before the first selected page have been rotated about the rotation axis M in a direction opposite to the rotation direction of the thumbnail image of the first selected page. However, in the invention, the thumbnail images of the pages before the first selected page may be rotated in the same rotation direction as the thumbnail image of the first selected page. Moreover, in the invention, the rotation angle θ1 of the first selected page may be 0°. Furthermore, in the invention, the rotation angles of the respective thumbnail images may be the same. Furthermore, in the invention, the thumbnail images of the pages within a predetermined range from the first selected page may have the same rotation angle as the thumbnail image of the first selected page. Furthermore, the thumbnail images of the pages outside the predetermined range from the first selected page may have a larger rotation angle than the thumbnail image of the first selected page.

In the invention, as shown in FIG. 41, the image of the first selected page and the thumbnail images may be arranged and displayed so that the image of the first selected page does not overlap with the thumbnail images.

Moreover, in the above-described embodiment, both the first selected image P and the thumbnail images P11 have been displayed at the same time. However, in the invention, only the thumbnail images P11 may be displayed without displaying the first selected image P. When displaying only the thumbnail images P11, the thumbnail images may have a larger size than that when they are displayed together with the first selected image P.

In the invention, a position input device that acquires information of a position of the display unit 1 which is touched by a stylus pen may be provided to the electronic apparatus 1000. The position or the moving trajectory of the stylus pen may be acquired based on the position information obtained by the position input device, and the respective units of the electronic apparatus 1000 may be controlled in accordance with the acquired position or moving trajectory. Moreover, a function of inputting a search keyword may be provided so as to search for a page including a keyword input by the stylus pen. Moreover, the page found through searching may be used as the second selected page, and the second selected page found through searching may be displayed with a gap between the second selected page and the pages which are before and after the selected page similarly to the above-described embodiment. A number of second selected pages may be found through searching.

In the invention, the residual image removal process may be performed before rewriting the selected image P.

In the above-described embodiment, although the residual image removal process changes all the pixels so as to have the same gradation by changing all the pixels to black based on the entirely black image and then changing all the pixels to white based on the entirely white image, the residual image removal process is not limited to this process.

In the residual image removal process of the invention, a voltage that causes pixels to appear black may not be applied to the pixel electrodes of the pixels which appear black in the displayed image before the residual image removal process is performed, and a voltage that causes pixels to appear black may be applied to the pixel electrodes of the pixels which appear white in the displayed image, to thereby change all the pixels to black, and all the pixels may be changed to white based on the entirely white image.

Moreover, in the residual image removal process of the invention, a voltage that causes pixels to appear white may not be applied to the pixel electrodes of the pixels which appear white in the displayed image before the residual image removal process is performed, and a voltage that causes pixels to appear white may be applied to the pixel electrodes of the pixels which appear black in the displayed image, to thereby change all the pixels to white, and all the pixels may be changed to black based on the entirely black image.

Moreover, in the invention, the residual image removal process may be a process of displaying the entirely black image and the entirely white image and displaying an image in which white and black are reversed in the image displayed after the residual image removal process, and an image may be displayed after the residual image removal process has been performed.

Furthermore, in the invention, the residual image removal process may be a process of displaying an image in which white and black are reversed in a newly displayed image, and a new image in which white and black are not reversed may be displayed after the residual image removal process has been performed.

Furthermore, in the above-described embodiment, although all the pixels of the display unit were driven when performing the residual image removal process, rather than driving all the pixels, only the pixels in a region where the thumbnail images are displayed before the residual image removal process is performed may be driven.

The entire disclosure of Japanese Patent Application No. 2011-026368, filed Feb. 9, 2011 is expressly incorporated by reference herein.

What is claimed is:

1. A display control method for displaying an image on a display unit which includes a plurality of scanning lines, a plurality of data lines, and a plurality of pixels formed corresponding to the intersections between the plurality of scanning lines and the plurality of data lines, and which displays an image using a plurality of particles of a first color and a plurality of particles of a second color included in the pixels, comprising:
generating thumbnail images to be displayed on the display unit;
displaying the thumbnail images generated in the generating on the display unit; and
removing a residual image present on the display unit by moving the particles of the first color and the particles of the second color before removing the thumbnail images displayed on the display unit or reducing a display region of the thumbnail images.

2. The display control method according to claim 1,
wherein the residual image is removed before changing an image outside the display region of the thumbnail images in a state where the thumbnail images are displayed on the display unit.

3. The display control method according to claim 1,
wherein the gradations of the pixels are changed by a writing operation of applying a voltage to the pixels several times, and
wherein the method further includes
determining the pixels of which the gradation is to be changed among the plurality of pixels by comparing image data representing an image to be newly displayed on the display unit with scheduled image data representing an image scheduled to be displayed on the display unit by the writing operation being performed, and
starting the writing operation with respect to the pixels which are determined to be the pixels of which the gradation is to be changed and in which the writing operation is not being performed so that the pixels have a gradation set by the image data, and performing the writing operation with respect to the pixels which are determined to be the pixels of which the gradation is to be changed and in which the writing operation is being performed so that the pixels have a gradation set by the image data after the writing operation being performed is finished.

4. A display apparatus comprising:
a display unit which includes a plurality of scanning lines, a plurality of data lines, and a plurality of pixels formed corresponding to the intersections between the plurality of scanning lines and the plurality of data lines, and which displays an image using a plurality of particles of a first color and a plurality of particles of a second color included in the pixels;
a display image generation unit that generates thumbnail images to be displayed on the display unit;
a controller that causes the thumbnail images generated by the display image generation unit to be displayed on the display unit; and
a residual image removal unit that removes a residual image present on the display unit by moving the particles of the first color and the particles of the second color before removing the thumbnail images displayed on the display unit or reducing a display region of the thumbnail images.

5. An electronic apparatus comprising the display apparatus according to claim 4.
